(19) United States
(12) Patent Application Publication
(10) Pub. No.: US 2021/0352069 A1
(43) Pub. Date: Nov. 11, 2021

(54) LOCAL AUTHENTICATION VIRTUAL AUTHORIZATION

(71) Applicant: Citrix Systems, Inc., Ft. Lauderdale, FL (US)

(72) Inventors: Georgy Momchilov, Parkland, FL (US); James Page, Coral Springs, FL (US); Santosh Sampath, Bangalore (IN)

(21) Appl. No.: 16/871,728

(22) Filed: May 11, 2020

(51) Int. Cl. H04L 29/06; H04W 12/06

(52) U.S. Cl. CPC H04L 63/10; H04L 63/0815; H04W 12/06; H04L 63/0807; H04L 63/083; H04L 63/0272

(57) ABSTRACT

A computer system is provided. The computer system includes a memory, a network interface, and at least one processor coupled to the memory and the network interface. The processor is configured to intercept a request transmitted by an application hosted within a virtual computing session, the request being a request to be authorized to access a resource; pass the request to a virtualization agent hosted outside the virtual computing session; receive a response to the request, the response including a credential granting authorization to access the resource; and pass the response to the application to authorize the application to access the resource through use of the credential.

### BACKGROUND

Authentication systems identify an entity. Authorization systems determine rights granted to an entity. In combination, authentication and authorization systems enable efficient and secure assignment of resources within many organizations. These resources can include physical resources, such as physical space, equipment, or materials, and logical resources, such as data storage, software applications, and user data. Through the use of authentication and authorization systems, individuals can be identified and granted access to the resources needed to perform their assigned roles and tasks, thereby contributing to an organization's ability to achieve its goals.

Within the realm of logical resources, the most heavily utilized authentication mechanism is the user password. In fact, computer systems that rely on user passwords to authenticate an associated user identifier are nearly ubiquitous. User passwords benefit from their ability to be easily recognized by computer systems through standard input devices and without the need for sensors or other specialized hardware. Once authenticated via a user password, the associated user identifier provides an excellent basis for the granting of rights to particular user data, software applications, and data storage using any of a variety of authorization systems designed for rights management.

### SUMMARY

In one example, a computer system is provided. The computer system includes a memory, a network interface, and at least one processor coupled to the memory and the network interface. The processor is configured to intercept a request transmitted by an application hosted within a virtual computing session, the request being a request to be authorized to access a resource; pass the request to a virtualization agent hosted outside the virtual computing session; receive a response to the request, the response including a credential granting authorization to access the resource; and pass the response to the application to authorize the application to access the resource through use of the credential.

At least some examples of the computer system can include one or more of the following features. The request can include a scope parameter specifying a scope of access requested for the resource. The response can include a token granting the scope of access to the resource. The system can further include the virtualization agent. The virtualization agent can be configured to pass the request to a browser hosted locally to the virtualization agent. The virtualization agent can be further configured to receive the response and pass the response to another virtualization agent hosted within the virtual computing session. The virtualization agent can be further configured to intercept the response.

The system can further include the browser. The browser can be configured to pass the response to one or more of the virtualization agent and another virtualization agent hosted within the virtual computing session. In the system, the request can include an authorization request. The response can include an authorization response. The browser can be further configured to: transmit the authorization request to an authorization server; receive, from the authorization server, a request to authenticate a user as an owner of the resource; authenticate the user as the owner of the resource using one or more of biometrics and multi-factor authentication; transmit, to the authorization server, a response to the request to authenticate the user; and receive the authorization response from the authorization server. The request can include a callback parameter specifying a uniform resource identifier (URI) of the application. The system can further include the virtualization agent. The virtualization agent can be configured to rewrite the callback parameter to specify a URI of the virtualization agent prior to passage of the request to a browser hosted locally with the virtualization agent.

In another example, a method of authorizing an application hosted within a virtual computing session to access at least one resource using a computer system is provided. The method includes intercepting a request transmitted by the application, the request being a request to be authorized to access the at least one resource; passing the request to a virtualization agent hosted outside the virtual computing session; receiving a response to the request, the response including a token granting authorization to access the at least one resource; and passing the response to the application to authorize the application to access the at least one resource through use of the token.

At least some examples of the method can include one or more of the following features. Intercepting the request can include intercepting a request comprising a scope parameter specifying a scope of access. The method can further include passing, by the virtualization agent, the request to a browser hosted locally to the virtualization agent. The method can further include receiving, by the virtualization agent, the response; and passing, by the virtualization agent, the response to another virtualization agent hosted within the virtual computing session.

The method can further include passing, by the browser, the response to one or more of the virtualization agent and another virtualization agent hosted within the virtual computing session. In the method, the request can include an authorization request, the response can include an authorization response, and the method can further include transmitting, by the browser, the authorization request to an authorization server; receiving, from the authorization server, a request to authenticate a user as an owner of the at least one resource; authenticating, by the browser, the user as the owner of the at least one resource using one or more of biometrics and multi-factor authentication; transmitting, to the authorization server, a response to the request to authenticate the user; and receiving, by the browser, the authorization response from the authorization server. The method can further include rewriting a callback parameter of the request to specify a URI of the virtualization agent prior to passing the request to a browser hosted locally with the virtualization agent.

In another example, a non-transitory computer readable medium storing processor executable instructions to authorize an application hosted within a virtual computing session to access a resource using a computer system is provided. The instructions include instructions to intercept a request transmitted by the application, the request being a request to be authorized to access the resource; pass the request to a virtualization agent hosted outside the virtual computing session; receive a response to the request, the response including a token granting authorization to access the resource; and pass the response to the application to authorize the application to access the resource through use of the token.

At least some examples of the computer readable medium can include one or more of the following features. The instructions can further include instructions to pass, by the virtualization agent, the request to a browser hosted locally to the virtualization agent. The request can include an authorization request, the response can include an authorization response, and the instructions further comprising instructions to transmit, by the browser, the authorization request to an authorization server; receive, from the authorization server, a request to authenticate a user as an owner of the resource; authenticate, by the browser, the user as the owner of the resource using one or more of biometrics and multi-factor authentication; transmit, to the authorization server, a response to the request to authenticate the user; and receive, by the browser, the authorization response from the authorization server.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a local authentication virtual authorization (LAVA) system in accordance with an example of the present disclosure.

FIG. 2 is a sequence diagram illustrating interoperation of processes implemented by the LAVA system of FIG. 1 in accordance with an example of the present disclosure.

FIG. 3 is a flow diagram of a resource accessing process executed by a hosted application within a virtual computing session in accordance with an example of the present disclosure.

FIG. 4 includes three flow diagrams of three interrelated LAVA processes executed by a host virtualization agent, a local virtualization agent, and a local browser in accordance with an example of the present disclosure.

FIG. 5 is a block diagram of a LAVA system including an embedded browser in accordance with an example of the present disclosure.

FIG. 6 is a sequence diagram illustrating interoperation of processes implemented by the LAVA system of FIG. 5 in accordance with an example of the present disclosure.

FIG. 7 includes three flow diagrams of three interrelated LAVA processes executed by a host virtualization agent, a local virtualization agent, and a local, embedded browser in accordance with an example of the present disclosure.

FIG. 8 is a block diagram of a LAVA system with browser content redirection (BCR) in accordance with an example of the present disclosure.

FIG. 9 is a sequence diagram illustrating interoperation of processes implemented by the LAVA system of FIG. 8 in accordance with an example of the present disclosure.

FIG. 10 includes two flow diagrams of two interrelated LAVA processes executed by a host virtualization agent and a BCR service in accordance with an example of the present disclosure.

FIG. 11 is a block diagram of a LAVA system with one or more browser helper objects (BHOs)/extensions/hooks in accordance with an example of the present disclosure.

FIG. 12 is a sequence diagram illustrating interoperation of processes implemented by the LAVA system of FIG. 11 in accordance with an example of the present disclosure.

FIG. 13 includes three flow diagrams of three interrelated LAVA processes executed by a local virtualization agent, a local browser, and one or more browser helper objects/browser extensions/hooks in accordance with an example of the present disclosure.

FIG. 14 is a block diagram of a LAVA system with a uniform resource identifier (IJRI) scheme handler in accordance with an example of the present disclosure.

FIG. 15 is a sequence diagram illustrating interoperation of processes implemented by the LAVA system of FIG. 14 in accordance with an example of the present disclosure.

FIG. 16 includes three flow diagrams of three interrelated LAVA processes executed by a local virtualization agent, a local browser, and an operating system (OS) in accordance with an example of the present disclosure.

FIG. 17 is a block diagram of a LAVA system with a URI rewriter in accordance with an example of the present disclosure.

FIG. 18 is a sequence diagram illustrating interoperation of processes implemented by the LAVA system of FIG. 17 in accordance with an example of the present disclosure.

FIG. 19 is a flow diagram of a LAVA process executed by a local virtualization agent.

FIG. 20 is a block diagram of a network environment of computing devices in which various aspects of the present disclosure can be implemented.

FIG. 21 is a block diagram of the LAVA system of FIG. 1 as implemented by a configuration of computing devices in accordance with an example of the present disclosure.

FIG. 22 is a block diagram of the LAVA system of FIG. 8 as implemented by a configuration of computing devices in accordance with an example of the present disclosure.

### DETAILED DESCRIPTION

As summarized above, at least some examples described herein are directed to systems and methods that enable local authentication of users who seek authorization to access protected resources within a virtual computing session. These systems and methods overcome several disadvantages of other authentication and authorization systems. For instance, by enabling local authentication of users, the systems and methods described herein can utilize local hardware (e.g., biometric sensors and/or trusted platform modules) to authenticate a user more securely and conveniently than is possible via the use of passwords.

In fact, the use of passwords as an authentication mechanism is a global security problem. Passwords are not secure, are becoming less convenient for users, and present privacy concerns. Moreover, at the enterprise level, an effective password policy is not scalable. More specifically, regarding security, passwords at endpoint devices are subject to phishing attacks. Further, passwords at the host are susceptible to stealing attacks, even where the passwords are hashed, and regardless of whether they are stored in dedicated or cloud based storage. Regarding convenience, remembering passwords for different accounts becomes challenging to a user as the number of the user's accounts increase. To alleviate this, the user may choose to save their passwords securely in the credential manager of an endpoint device. However, if the endpoint device fails to retrieve the saved passwords securely, the user will be required to perform additional actions to identify herself and to create a new password. Moreover, passwords are recommended to be changed at regular intervals. All of the above contribute to the inconvenience endured by users of password-based authentication systems.

The emergence of OAuth, an open standard for authorization, has ameliorated some of the disadvantages of password-based authentication by decoupling authorization from authentication. OAuth 2.0 as described in Request for Comments (RFC) 6479 and RFC 8252 enables an application to obtain secure, limited access to a user's protected resources (e.g., data) without requiring the user to provide a password to the application.

Some applications hosted within a virtual computing session are designed to use federation and benefit from OAuth 2.0. While these applications would gain security and convenience benefits from robust biometric and/or multifactor authentication mechanisms, such endpoint device capabilities are not readily available within virtual computing sessions. Rather, within virtual computing sessions, physical trusted platform modules (TPMs), which serve as a foundation for such robust authentication mechanisms, either do not exist or do not persist between the virtual computing sessions. Common types of virtual computing sessions, such as those provided by remote desktop session hosts and pooled desktops, or Citrix Secure Browser™ service combine different physical hardware (and therefore different TPM instances) with persistent OS instances, identity disks, and user layers for each new user. As such, to properly utilize the robust authentication mechanisms provided by endpoint devices, an application needs to interact locally with the hardware of an endpoint device, not with virtual hardware within a virtual computing session.

To address the disadvantages described above, as well as other issues, local authentication virtual authorization (LAVA) systems and processes are provided. These systems and processes seamlessly redirect OAuth workflows initiated by an application hosted within a virtual computing session to an endpoint device. At the endpoint device, a browser executing locally to the endpoint device continues the OAuth workflow, authenticates a user of the hosted application via robust authentication mechanisms that utilize hardware and software local to the endpoint device, and redirects the OAuth workflow back to the hosted application within the virtual computing session. The hosted application then, in turn, completes the OAuth workflow. Upon completion of the OAuth workflow, the hosted application possesses a token that enables the hosted application to access user resources (e.g., user data) protected by a resource server that supports OAuth authorization.

In some examples, a virtualization infrastructure, such as the HDX™ virtualization infrastructure commercially available from Citrix Systems of Fort Lauderdale, Florida, in the United States, implements the redirection of OAuth workflows as described above. In these examples, virtualization agents executing on the endpoint device and within the virtual computing session interoperate with a client-side local browser, a server-side hosted application, and one another as will be described in further detail below. In some examples, the local browser is embedded within a virtual workspace application, such as the Citrix Workspace™ application, commercially available from Citrix Systems. Alternatively or additionally, in some examples, the local browser is an independent program resident on the endpoint device.

In certain examples, the application hosted within the virtual computing session is a hosted browser, initiates a hosted browser, or is capable of processing uniform resource identifiers (URIs). This hosted application initiates an OAuth workflow by transmitting, to an authorization server, a request for authorization to access resources protected by a resource server. In these examples, the virtualization agent executing within the virtual computing session intercepts these authorization requests. For example, this host virtualization agent may monitor and detect (or may simply receive via OS intervention) particular URIs, such as particular uniform resource locators (URLs), originating from the hosted application using any one or a combination of processes described below. Further, the host virtualization agent passes intercepted authorization requests (e.g., over a virtual communication channel) to the virtualization agent executing locally on the endpoint device. This local virtualization agent further passes the authorization request to the local browser. In some examples, the local virtualization agent executes any of a combination of processes, again discussed further below, to ensure that the local virtualization agent receives an authorization response corresponding to the authorization request.

Continuing these examples, the local browser attempts to authenticate the user of the hosted application using the robust authentication mechanisms discussed herein. Where this authentication is successful, the local browser receives the authorization response corresponding to the authorization request. The authorization response can include, for example, an authorization code grant, as codified in RFC 6749. The authorization response can include a URI that contains a URI-encoded query string to complete an OAuth workflow. Alternatively, the authorization response can include a token to access the resources protected by the resource server. Where the authentication is not successful, the authorization response includes an indication of the same.

Next, in these examples, the local browser passes the authorization response to the local virtualization agent. The local virtualization agent passes the authorization response to the host virtualization agent. The host virtualization agent invokes the hosted application and passes the authorization response to the hosted application. The processes executed by the host virtualization agent to invoke the hosted application and pass the authorization response to the hosted application vary between examples, as will be described further below. Where the authorization response includes an authorization code grant, the hosted application completes the OAuth workflow by requesting and receiving the token from the authorization server. Regardless of how the hosted application acquires the token, the hosted application next uses the token to access resources protected by the resource server. Where the authorization response includes an indication of authentication failure, the hosted application provides an indication of the same to the user.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### LAVA System

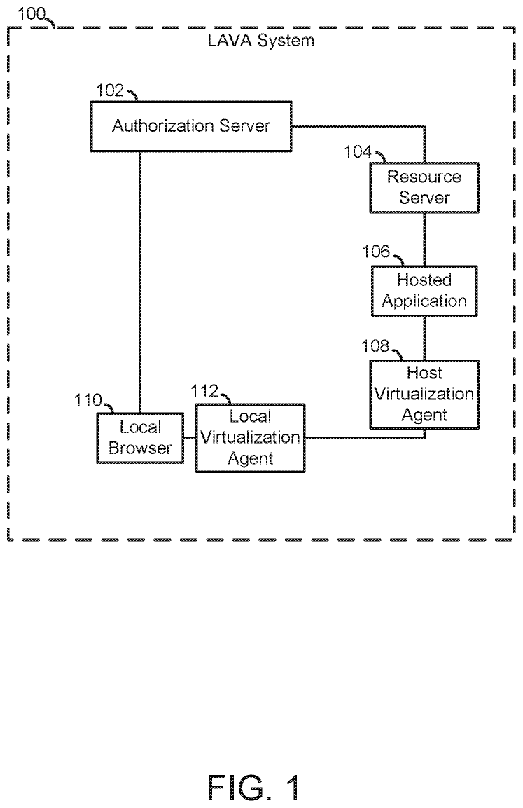

In some examples, a LAVA system is configured to robustly authenticate a user of an application hosted within a virtual computing session to an authorization server using hardware and software local to an endpoint device of the user. FIG. 1 illustrates a logical architecture of a LAVA system 100 in accordance with these examples.

As shown in FIG. 1, the LAVA system 100 includes an authorization server 102, a resource server 104, a hosted application 106, a host virtualization agent 108, a local browser 110, and a local virtualization agent 112. FIG. 1 also illustrates lines of communication between these computer-implemented processes. Details regarding these communications are provided below, but it should be noted that the depicted lines of communication can include inter-process communication (e.g., where two or more of the computer-implemented processes illustrated in FIG. 1 reside within the same execution environment) and network-based communication (e.g., where two or more of the processes reside in different execution environments coupled to one another by a computer network).

In some examples, the authorization server 102 and the resource server 104 are collectively configured to control access to resources protected by the resource server 104 using an authorization protocol such as the OAuth 2.0 protocol. These protected resources can include, but are not limited to, user data representative of contacts, documents, videos, photographs, and the like. In these examples, the resource server 104 is configured to expose an application programming interface (API) that receives, processes, and transmits responses to request messages received from calling processes (e.g., the hosted application 106, the local browser 110, etc.). These request messages can include, for example, requests to access the protected resources. Such resource requests can include identifiers of the protected resource and the scope of access requested. In certain examples, the resource server 104 is configured to respond to a resource request by determining whether the resource request includes an unexpired token authorized for the requested scope of access to the protected resources. In these examples, the resource server 104 is further configured to respond to resource requests that include such a token by providing the requested scope of access to the protected resources. Conversely, in these examples, the resource server 104 is also configured to respond to resource requests that lack such a token by transmitting a resource response message that denies the calling process access to the protected resources. In some examples, this resource response indicates the basis for the denial (e.g., that the resource request lacked proper authority to access the protected resource) and/or a URI of an authorization server (e.g., the authorization server 102) configured to grant tokens authorizing access of the requested scope to the protected resources.

Continuing these examples, the authorization server 102 is also configured to expose an API that receives, processes, and transmits responses to request messages from calling processes (e.g., the hosted application 106, the local browser 110, etc.). These request messages can include, for example, requests to be authorized for an identified scope of access to protected resources. Such authorization requests can include identifiers of the protected resource, the scope of access requested, and a type of authorization credential requested (e.g., a code or a token), among other parameters that are described below. The authorization server 102 is configured to respond to an authorization request by interoperating with the calling process (e.g., the local browser 110) to authenticate the user using, for example, robust authentication mechanisms such as multifactor authentication, biometrics, and/or other authentication mechanisms made available by biometric sensors, TPMs, and other endpoint device hardware and software. The authorization server 102 is further configured to transmit an authorization response including an authorization credential of the requested type where the user is successfully authenticated and to transmit an authorization response that denies the authorization credential to the calling process where the user is not successfully authenticated.

As shown in FIG. 1, the host virtualization agent 108 and the local virtualization agent 112 are configured to interoperate within a virtualization infrastructure. This virtualization infrastructure enables an application (e.g., the hosted application 106) executing within a first physical computing environment to be accessed by a user of a second physical computing environment (e.g., an endpoint device) as if the application was executing within the second physical computing environment. Within the virtualization infrastructure, the host virtualization agent 108 is configured to make a computing environment in which it operates available to execute virtual computing sessions. The host virtualization agent 108 can be further configured to manage connections between these virtual computing sessions and other processes within the virtualization infrastructure, such as the local virtualization agent 112. In a complementary fashion, the local virtualization agent 112 is configured to instigate and connect to the virtual computing sessions managed by the host virtualization agent 108. The local virtualization agent 112 is also configured to interoperate with other processes executing within its computing environment (e.g., the local browser 110) to provide those processes with access to the virtual computing sessions and the virtual resources (e.g., the hosted application 106) therein. Within the context of a Citrix HDX™ virtualization infrastructure, the host virtualization agent 108 can be implemented as, for example, a virtual delivery agent installed on a physical or virtual server or desktop and the local virtualization agent 112 can be implemented as a local service in support of, for example, a Citrix Workspace™ client agent or Citrix Receiver™ for hypertext markup language (HTML) 5 browsers.

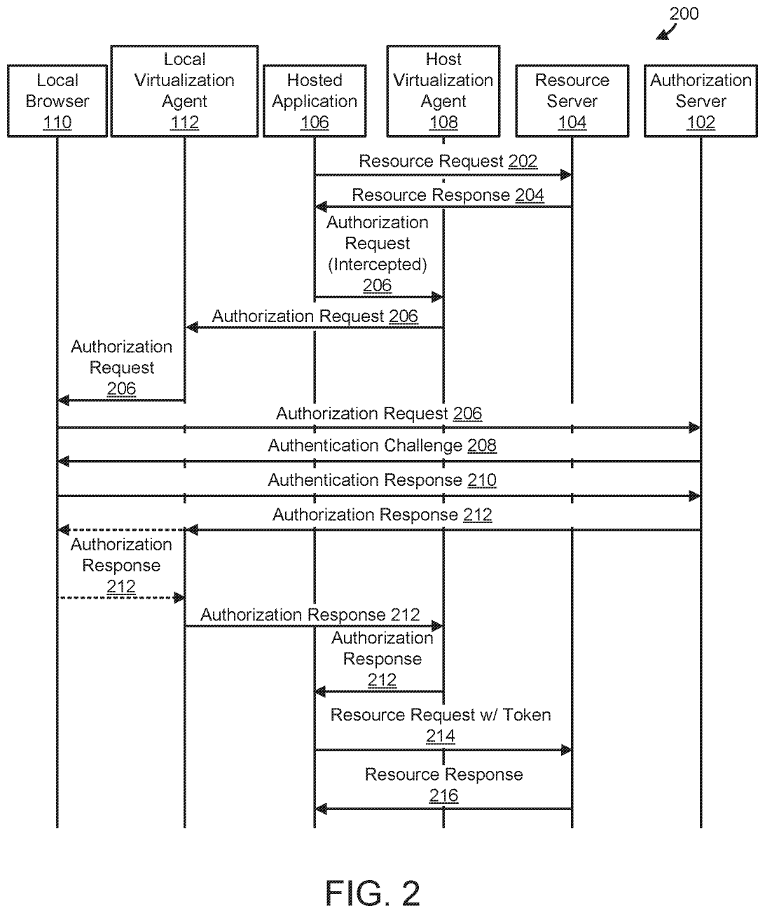

In some examples, the host virtualization agent 108 and the local virtualization agent 112 are configured to execute additional processes in support of the LAVA system 100. Examples of these processes are described below with reference to FIGS. 2, 4, 6, 7, 9, 10, 12, 13, 15, 16, 18 and 19.

As illustrated in FIG. 1, the hosted application 106 is generally configured to provide a user with valuable functionality at least in part by interoperating with one or more servers (e.g., web servers, database servers, application servers, etc.). In some examples, the hosted application 106 is more specifically configured to request and utilize resources protected by the resource server 104. For example, the hosted application 106 may be an email application configured to access a list of social media contacts protected by the resource server 104 so that the email application can more easily generate emails to those contacts. Thus, the email application is configured to request access to the list of social media contacts from the resource server 104 and thereby initiate an authorization process supported by the resource server 104 (e.g., an OAuth 2.0 workflow). Further details of example processes that the hosted application 106 is configured to execute are described further below with reference to FIGS. 2, 3, 6, 9, 12, 15, and 18. It should be noted that the hosted application 106 can be one or more of an application native to an OS running within the host virtual computing session, a browser embedded within such a native application, or a stand-alone, commercially available browser, among other types of software applications. In some examples, the hosted application 106 is a browser implemented via the Citrix Secure Browser™ service. In some examples, the hosted application includes a web-based application and/or a software as a service (SaaS) application.

As shown in FIG. 1, the local browser 110 is generally configured to provide a browser execution environment capable of rendering and/or interpreting content ranging from simple HTML pages to complex JavaScript code. In some examples, the local browser 110 is more specifically configured to take part in LAVA processes in which the local browser 110 accesses local hardware and software to execute robust authentication mechanisms and exchanges messages with other processes to enable the hosted application 106 to complete an authorization process. Further details of example processes that the local browser 110 is configured to execute are described further below with reference to FIGS. 2, 4, 6, 7, 9, 12, 13, 15, 16, and 18. It should be noted that the local browser 110 can be one or more of a browser embedded within another application or a stand-alone, commercially available browser, among other types of browsers.

FIG. 2 is a sequence diagram that illustrates one example of a successfully executed LAVA process 200. As shown in FIG. 2, the process 200 includes interoperations between the computer-implemented processes illustrated in FIG. 1 that collectively accomplish robust authentication of a user within an authorization workflow.

The process 200 starts with a hosted application (e.g., the hosted application 106 of FIG. 1) transmitting a resource request 202 to a resource server (e.g., the resource server 104 of FIG. 1). For instance, the resource request 202 can be, or include, a URI that identifies a protected resource (e.g., user data protected by the resource server) and a scope of access to the protected resource. In some examples, the resource request 202 can be in the form of an API call supported by the resource server.

Continuing the process 200, the resource server receives, processes, and responds to the resource request 202. In this example, the resource request 202 lacks a token authorized to access the protected resource at the requested scope. As such, the resource server identifies this deficiency and responds to the resource request 202 by transmitting, to the hosted application, a resource response 204 that denies access to the protected resource. This response can, in some examples, include an identifier of an authorization server (e.g., the authorization server 102 of FIG. 1) that can grant tokens authorized for the requested scope of access to the protected resource.

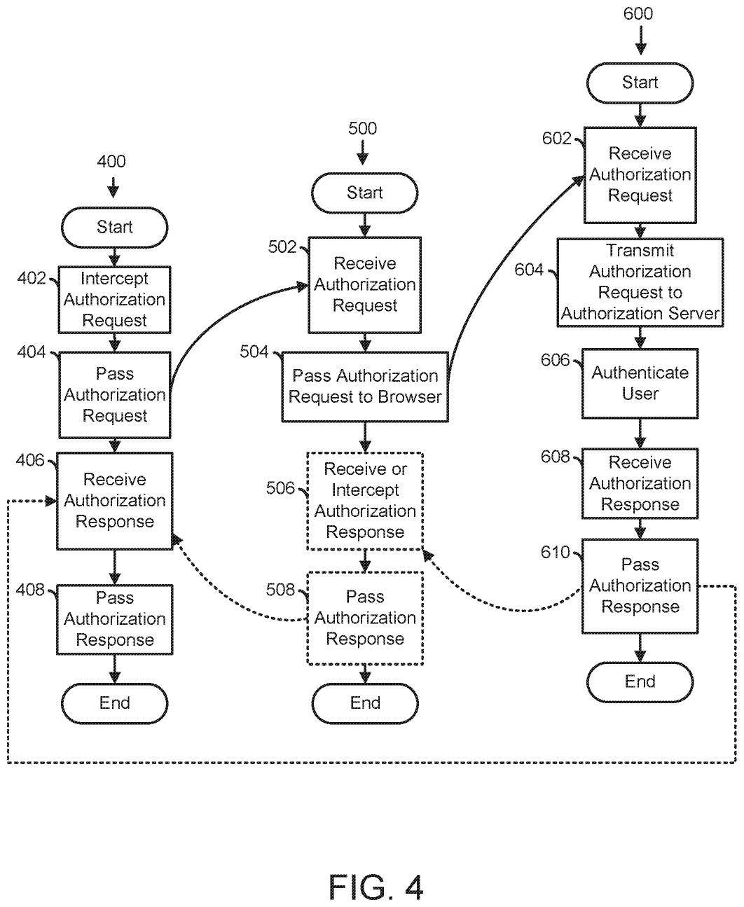

Continuing the process 200, the hosted application receives, processes, and responds to the resource response 204. In this example, the hosted application generates and attempts to transmit an authorization request 206 to the authorization server. The authorization request 206 can include, for example, an identifier of the protected resource and an identifier of the scope of access sought. In examples where the authorization server supports AOuth 2.0, the authorization request 206 can include an identifier of a type of authorization credential sought (e.g., a code or a token), an identifier of the hosted application, and a URI of a callback function (e.g., the redirect_uri parameter). In this example, a host virtualization agent (e.g., the host virtualization agent 108 of FIG. 1) intercepts the authorization request 206 and passes the intercepted authorization request 206 to a local virtualization agent (e.g., the local virtualization agent 112 of FIG. 1). This interception can be accomplished using any combination of a variety of techniques including, for example, code injection via a browser helper object (BHO)/extension to a browser executing, or embedded within, the hosted application; utilization of one or more hooks within the hosted application; registration of the host virtualization agent as a URI scheme handler of authorization request URIs; and/or scripting of a proxy server utilized by the hosted application. Details describing these techniques are articulated in further detail below with reference to operation 402 of FIG. 4.

Continuing the process 200, the local virtualization agent receives the authorization request 206. The local virtualization agent then passes the authorization request 206 to a browser (e.g., the local browser 110). This browser can be executing locally on an endpoint device of the user of the hosted application. In some examples, the endpoint device is associated with the user in response to the user authenticating herself to the endpoint device.

Continuing the process 200, the local browser receives, loads, and transmits the authorization request 206 to the authorization server. The authorization server transmits an authentication challenge 208 to the local browser. The authentication challenge 208 can include identifiers of one or more authentication mechanisms that the authorization server supports and/or requires to authenticate a user as the owner of the protected resources. These authentication mechanisms can utilize robust authentication mechanisms available to the local browser as an application resident on an endpoint device. The robust authentication mechanism can include biometric authentication mechanisms (e.g., fingerprint scans, retinal scans, facial recognition, voice recognition, etc.) and/or multi-factor authentication mechanisms based on biometric factors, passwords, etc.

Continuing the process 200, the local browser collects authentication information from the user of the endpoint device. This authentication information can include information required to satisfy the authentication mechanisms required by the authorization server. It should be noted that, in some examples, the local browser can be configured to collect the authentication information prior to receiving the authentication challenge 208 from the authorization server. For example, the local browser can be configured to collect authentication information upon boot of the endpoint device executing the local browser, upon initiation of the browser (where that initiation is distinct from endpoint device boot), upon expiration of a timer, or in response to some other event. It should also be noted that, in some examples, the authentication information can include a credential that indicates that the user has been authenticated by a service (e.g., a domain controller) trusted by the authorization server. In these examples, the authorization server authenticates the user by processing the credential to ensure its authenticity (e.g., via private/public key encryption/decryption, etc.).

Continuing the process 200, the local browser transmits an authentication response 210 including the authentication information to the authorization server. The authorization server receives the authentication response 210, parses the authentication response 210 to identify and retrieve the authentication information, and attempts to authenticate the user with the authentication information. Next, the authorization server generates and transmits an authorization response 212. Where the authorization server successfully authenticated the user, the generated authorization response 212 includes the requested authorization credential (e.g., a code or a token). Where the authorization server failed to successfully authenticate the user, the generated authorization response 212 includes an indication that the authorization server was unable to authenticate the user (e.g., an error message). Next, the authorization server attempts to transmit the authorization response 212 to the local browser.

Continuing the process 200, either the local browser receives the authorization response 212 or the local virtualization agent intercepts the authorization response 212. This interception can be accomplished using any combination of a variety of techniques including, for example, code injection via a browser helper object (BHO)/extension to the local browser; utilization of one or more hooks within the local browser; registration of the local virtualization agent as a URI scheme handler of authorization responses; and/or scripting of a proxy server utilized by the local browser. Where the local browser receives the authorization response 212, the local browser passes the authorization response 212 to the local virtualization agent.

Continuing the process 200, the local virtualization agent intercepts/receives the authorization response 212 and passes the authorization response 212 to the host virtualization agent. The host virtualization agent receives the authorization response 212 and passes the authorization response 212 to the hosted application. The hosted application receives the authorization response, parses it to retrieve the token, and transmits a resource request 214 with the token to the resource server. The resource server 104 receives, processes, and responds to the resource request 214 by generating and transmitting a resource response 216 granting the scope of access requested in the resource request 214 and authorized by the token. Upon completion of the LAVA process 200, the hosted application can access the protected resources for subsequent processing.

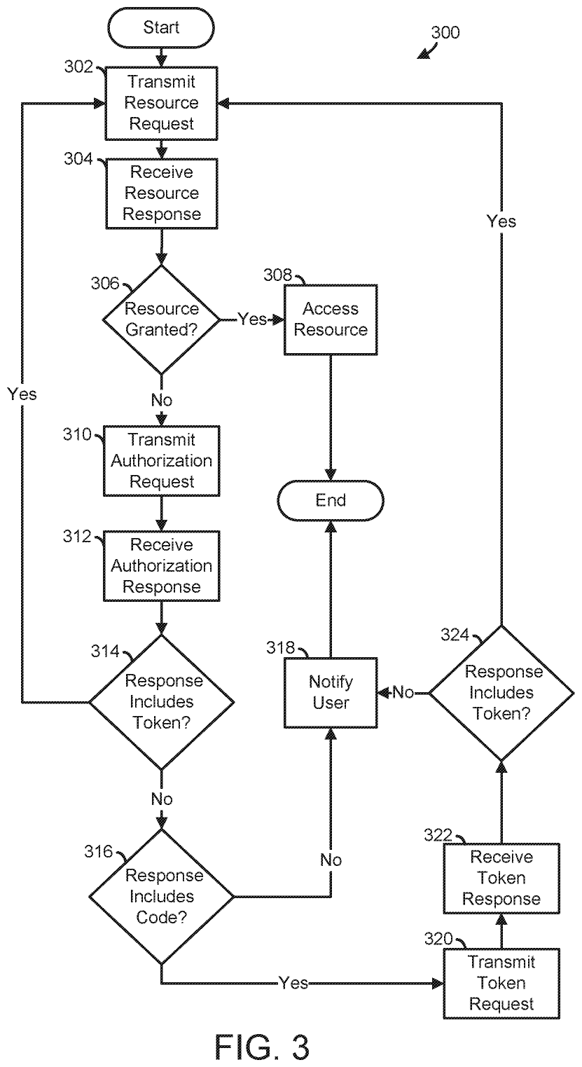

FIG. 3 is a flow diagram illustrating a process 300 useful to access resources protected by a resource server (e.g., the resource server 104 of FIG. 1). The process 300 can be executed, for example, by an application (e.g., the hosted application 106 of FIG. 1) hosted within a virtual computing session.

As shown in FIG. 3, the process 300 starts with the hosted application transmitting 302 a resource request to the resource server. For instance, the hosted application can generate and transmit a hypertext transfer protocol secure (HTTPS) POST or GET to the resource server that includes an identifier of the protected source and a scope of access requested. Next, the hosted application receives 304 a resource response from the resource server. For instance, the hosted application can receive an HTTPS response from the resource server. The hosted application parses the resource response to retrieve response data indicative of whether it has been granted access to the requested, protected resources and additional, related response data. This additional, related response data can include, for example, an identifier of an authorization server (e.g., the authorization server 102 of FIG. 1) where the response data indicates access of the requested scope to the protected resources is denied. Alternatively, this additional, related response data can include, for example, a URI to access the protected data at the requested scope where the response data indicates that access of the requested scope to the protected resources is granted.

Next, the hosted application determines 306 whether it has been granted access to the protected resources. Where the hosted application determines 306 that it has been granted access to the protected resources, the hosted application accesses 308 the protected resources to utilize them in subsequent processing of ostensible value to the user and the process 300 ends. Where the hosted application determines 306 that it has not been granted access to the protected resources, the hosted application transmits 310 an authorization request to the authorization server.

Continuing the process 300, the hosted application receives 312 an authorization response from the authorization server. The hosted application parses the authorization response to determine 314 whether the authorization response includes an authorization credential (e.g., a code or token). Where the hosted application determines 314 that the authorization response includes a token, the hosted application returns to transmit 302 a resource request. Where the hosted application determines 314 that the authorization response does not include a token, the hosted application determines 316 whether the authorization response includes a grant code. Where the hosted application determines 316 that the authorization response does not include a grant code, the hosted application notifies 318 the user, and the process 300 ends.

Continuing the process 300, where the hosted application determines 316 that the authorization response includes a grant code, the hosted application generates and transmits 320 a token request to the authorization server. The hosted application receives 322 a token response. The hosted application determines 324 whether the token response includes a token. Where the hosted application determines 324 that the token response does not include a token, the hosted application notifies 318 the user and the process 300 ends. Where the hosted application determines 324 that the token response includes a token, the hosted application returns to transmit 302 a resource request.

FIG. 4 is a combined flow diagram that illustrates three related processes 400, 500, and 600 useful to implement an overall LAVA process, such as the LAVA process 200 described above with reference to FIG. 2. The processes 400, 500, and 600 can be respectively executed by a host virtualization agent (e.g., the host virtualization agent 108 of FIG. 1), a local virtualization agent (e.g., the local virtualization agent 112 of FIG. 1), and a browser (e.g., the local browser 110 of FIG. 1).

As shown in FIG. 4, the process 400 starts with the host virtualization agent intercepting 402 an authorization request from a hosted application (e.g., the hosted application 106 of FIG. 1) to an authorization server (e.g., the authorization server 102 of FIG. 1). The authorization request can be for the requested scope of access to a protected resource. The authorization request can include an identifier of the protected resource and a scope of access for which authorization is requested. Processes executed to intercept 402 the authorization request can vary between examples.

For instance, in examples where the hosted application is, includes, or is executed within a browser or some other program configured to execute JavaScript code, the host virtualization agent includes a BHO/extension active within the hosted application that monitors URIs loaded by the hosted application for authorization request URIs. Upon identifying an authorization request URI, the BHO/extension injects JavaScript code into the hosted application that intercepts 402 the authorization request. In some examples, the JavaScript code is injected into the hosted application's page. In some examples, the JavaScript code is injected into a background script of the BHO/extension. In these examples, the BHO/extension active within the hosted application can include a proxy server extension and/or a micro-virtual private network (VPN) extension. Alternatively or additionally, in some examples, the host virtualization agent can inject code into, and/or activate, hooks within the hosted application and/or browser to configure the hooks to intercept 402 subsequent authorization requests.

Alternatively or additionally, in some examples, the host virtualization agent can register itself as a URI scheme handler with the OS supporting execution of the hosted application. In these examples, the OS intercepts 402 the HTTP and HTTPS messages addressed to the registered URI and passes the intercepted messages to the host virtualization agent for processing. The registered URI can be URIs supported by the authorization server, thereby directing the subsequent authorization request for the requested scope of access to the one or more protected resources to the host virtualization agent for processing. Alternatively or additionally, in examples where the hosted application is not configured to execute JavaScript code, the host virtualization agent identifies authorization requests transmitted by the hosted application that request authorization for a scope of access to one or more protected resources. In these examples, the host virtualization agent includes a proxy server, or program embedded therein that monitors for and intercepts 402 authorization requests transmitted by the hosted application.

Continuing the process 400, the host virtualization agent passes 404 the intercepted authorization request to a local virtualization agent (e.g., the local virtualization agent 112 of FIG. 1). Processes executed to pass 404 the authorization request can vary between examples. For instance, where the virtualization infrastructure supports browser content redirection (BCR), the host virtualization agent passes 404 the intercepted authorization request by using BCR to both prevent the hosted application from processing the intercepted authorization request and to transmit the intercepted authorization request to the local virtualization agent. BCR technology is commercially available within the HDXTM virtualization infrastructure. Alternatively or additionally, in examples where the virtualization infrastructure does not support BCR, the host virtualization agent passes 404 the intercepted authorization request to the local virtualization agent by, for example, transmitting a message to the local virtualization agent that includes the authorization request.

Continuing the process 400, the host virtualization agent receives 406 an authorization response passed from the local virtualization agent or a local browser (e.g., the local browser 110 of FIG. 1). The authorization response can include, for example, a token authorized for the scope of access to the protected resource identified in the previously intercepted 402 authorization request. Processes executed to receive 406 the authorization response can vary between examples. For instance, where the virtualization infrastructure supports BCR, the host virtualization agent receives 406 the authorization response from the local browser by operation of BCR. Alternatively or additionally, in examples where the virtualization infrastructure does not support BCR, the host virtualization agent receives 406 the authorization response via a message from the local virtualization agent.

Continuing the process 400, the host virtualization agent passes 408 the authorization response to the hosted application, and the process 400 ends. In some examples, the host virtualization agent passes 408 the authorization response to the hosted application by transmitting a message to the hosted application that includes the authorization response. Alternatively or additionally, the host virtualization agent or the hosted application can register the hosted application as a URI scheme handler for URIs of authorization responses. In these examples, the host virtualization agent passes 408 the authorization response to the hosted application by attempting to load the URI of the authorization response, which in turn causes the OS executing within the virtual computing session to initiate (if needed) the hosted application and to pass the authorization response to the hosted application.

As shown in FIG. 4, the process 500 starts with the local virtualization agent receiving 502 the authorization request from the host virtualization agent. Processes executed to receive 502 the authorization request can vary between examples. For instance, where the virtualization infrastructure supports BCR, the local virtualization agent receives 502 the authorization request from host virtualization agent by operation of BCR. Alternatively or additionally, in examples where the virtualization infrastructure does not support BCR, the local virtualization agent receives 502 the authorization request via a message from the host virtualization agent.

Continuing the process 500, the local virtualization agent passes 504 the authorization request to the local browser. Processes executed to pass 504 the authorization request can vary between examples. For instance, where the virtualization infrastructure supports BCR, the local virtualization agent passes 504 the authorization request to the local browser by operation of BCR. Alternatively or additionally, in examples where the virtualization infrastructure does not support BCR, the local virtualization agent passes 504 the authorization request to the local browser via a message. In some examples, this message can include a request that the local browser load the authorization request. Alternatively or additionally, the local virtualiza don agent or the local browser can register the local browser as a URI scheme handler for URIs of authorization requests. In these examples, the host virtualization agent can pass 504 the authorization request to the local browser by attempting to load the URI of the authorization request, which in turn causes the local OS to initiate (if needed) the local browser and to pass the authorization response to the local browser.

Continuing the process 500, the local virtualization agent receives 506 an authorization response from the local browser or receives 506 the authorization response via interception. As illustrated in FIG. 4 by being rendered in dotted lines, reception 506 of the authorization response is optional. For instance, where the virtualization infrastructure supports BCR, the local virtualization agent does not receive 506 the authorization response. Alternatively or additionally, in examples where the virtualization infrastructure does not support BCR, the local virtualization agent can receive 506 the authorization response from the local browser via a message from a BHO/extension active within the local browser and/or intercept and receive 506 the authorization response. Processes executed to intercept the authorization response can vary between examples. For instance, in some examples, the local virtualization agent includes a BHO/extension active within the local browser that monitors URIs loaded by the local browser for authorization responses. Upon identifying an authorization response, the BHO/extension injects JavaScript code into the local browser that intercepts the authorization response. In these examples, the BHO/extension active within the local browser can include a proxy server extension and/or a micro-virtual private network (VPN) extension. Alternatively or additionally, in some examples, the local virtualization agent can inject code into, and/or activate, hooks within the local browser to configure the hooks to intercept authorization responses.

Alternatively or additionally, in some examples, the local virtualization agent can register itself as a URI scheme handler for authorization response URIs with the local OS. In these examples, the OS intercepts the HTTP and HTTPS messages addressed to the registered URI and passes the intercepted messages to the local virtualization agent for processing. The registered URI can be URIs supported by the authorization server, thereby directing the authorization responses for the requested scope of access to the one or more protected resources to the local virtualization agent for processing. Alternatively or additionally, the local virtualization agent can include a proxy server, or a program embedded therein, to monitor for and intercept the authorization responses.

Continuing the process 500, the local virtualization agent passes 508 the authorization response to the host virtualization agent 508. As illustrated in FIG. 4 by being rendered in dotted lines, passage 508 of the authorization response is optional. For instance, where the virtualization infrastructure supports BCR, the local virtualization agent does not pass 508 the authorization response to the host virtualization agent. Alternatively or additionally, in examples where the virtualization infrastructure does not support BCR, the local virtualization agent passes 508 the authorization request to the host virtualization agent via a message. Subsequent to the optional execution of the operation 508, the process 500 ends.

As shown in FIG. 4, the process 600 starts with the local browser receiving 602 the authorization request from the host virtualization agent. In response to reception of the authorization request, the local browser transmits 604 the authorization request to the authorization server. In some examples where the local browser is a pure HTML5-based browser, the authorization request may be wrapped in a message that instructs the local browser to open a new, separate execution container (e.g., a tab) prior to loading the authorization request and transmitting it to the authorization server. The local browser authenticates 606 a user of the hosted application via robust authentication mechanisms that utilize local hardware and software as described above.

Continuing the process 600, the local browser (and more specifically, in some examples, a BHO/extension active within the local browser) receives 608 an authorization response. The authorization response can include an authorization credential (e.g., a token or a code). The local browser passes 610 the authorization response to either the host virtualization agent (e.g., in examples that implement BCR) or the local virtualization agent (e.g., in examples that do not implement BCR), and the process 600 ends. The local browser can pass 610 the authorization response to the host virtualization agent by operation of BCR. The local browser can also pass 610 the authorization response to the local virtualization agent by generating and transmitting a message including the authorization credential to the local virtualization agent.

LAVA System with Embedded Browser

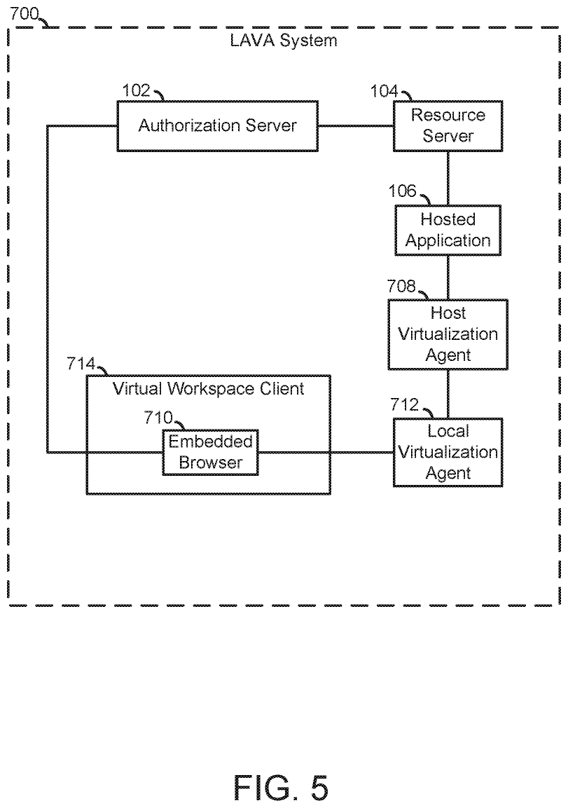

FIG. 5 illustrates a logical architecture of a LAVA system 700 in accordance with some examples disclosed herein. As shown in FIG. 5, the LAVA system 700 includes the authorization server 102, the resource server 104, and the hosted application 106 of FIG. 1. The LAVA system 700 further includes a host virtualization agent 708, a local virtualization agent 712, and a virtual workspace client 714. The virtual workspace client includes an embedded browser 710. Within the LAVA system 700, the embedded browser 710 descends from and inherits the attributes of the local browser 110 of FIG. 1. The host virtualization agent 708 descends from and inherits the attributes of the host virtualization agent 108 of FIG. 1. The local virtualization agent 712 descends from and inherits the attributes of the local virtualization agent 112 of FIG. 1. By virtue of their inheritance, each of the embedded browser 710, the host virtualization agent 708, and the local virtualization agent 712 can execute the processes executable by its ancestors. Some of the computer-implemented processes illustrated in FIG. 5 are described above with reference to FIG. 1. For purposes of brevity, those descriptions will not be repeated here, but each of these processes is configured to operate within the LAVA system 700 as each is configured to operate within the LAVA system 100 of FIG. 1. The description of any of the computer-implemented processes of the LAVA system 700 may be augmented or refined below. FIG. 5 also illustrates lines of communication between these computer-implemented processes. Details regarding these communications are provided below, but it should be noted that the depicted lines of communication can include inter-process communication (e.g., where two or more of the computer-implemented processes illustrated in FIG. 5 reside within the same execution environment) and network-based communication (e.g., where two or more of the processes reside in different execution environments coupled to one another by a computer network).

As shown in FIG. 5, the virtual workspace client 714 is a software program configured to deliver and manage a user's applications, data, and desktops in a consistent and secure manner, regardless of the user's device or location. The virtual workspace client 714 enhances the user experience by streamlining and automating those tasks that a user performs frequently, such as approving expense reports, confirming calendar appointments, submitting helpdesk tickets, and reviewing vacation requests. The virtual workspace client 714 allows users to access functionality provided by multiple enterprise applications—including “software as a service” (SaaS) applications, web applications, desktop applications, and proprietary applications—through a single interface. As shown in FIG. 5, the virtual workspace client 714 includes the embedded browser 710. The embedded browser 710 can be implemented, for example, using the Chromium Embedded Framework.

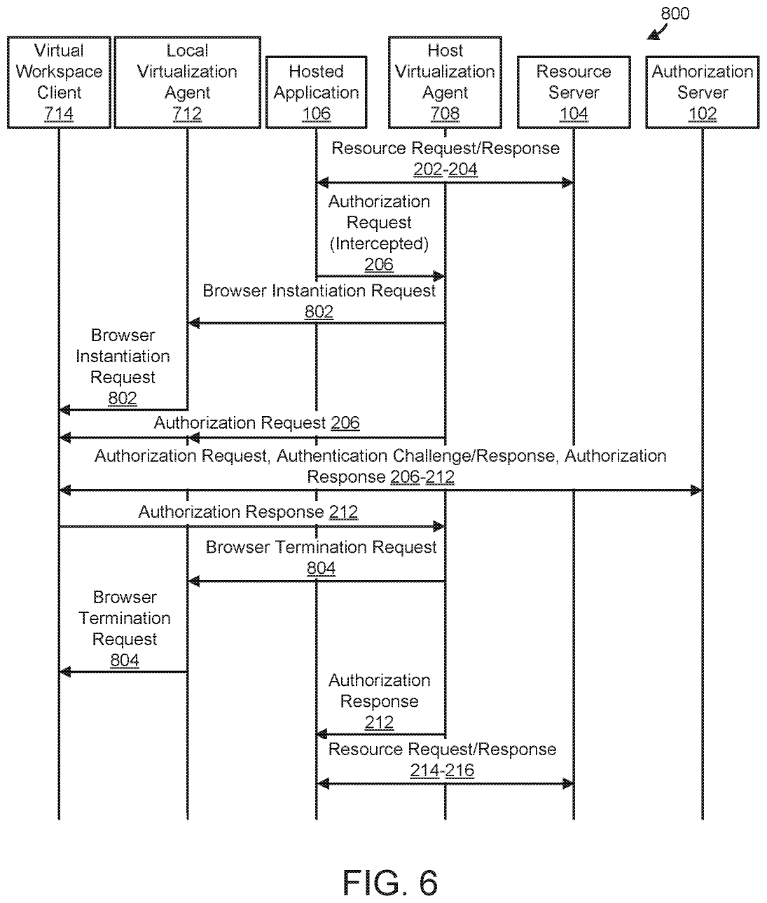

FIG. 6 is a sequence diagram that illustrates one example of a successfully executed LAVA process 800. As shown in FIG. 6, the process 800 includes interoperations between the computer-implemented processes illustrated in FIG. 5 that collectively accomplish robust authentication of a user within an authorization workflow. Some of the operations illustrated in FIG. 6 are described above with reference to FIG. 2. For purposes of brevity, those descriptions will not be repeated here, but each of these operations within the process 800 includes actions analogous to those of the corresponding operation within the process 200. The description of any of the operations of the process 800 may be augmented or refined below.

The process 800 starts with a hosted application (e.g., the hosted application 106 of FIG. 5) and a resource server 104 (e.g., the resource server 104 of FIG. 5) interoperating with one another to exchange and process the resource request/response pair 202-204 described above with reference to FIG. 2. Further, in this example, the hosted application generates and attempts to transmit the authorization request 206 described above with reference to FIG. 2 to an authorization server (e.g., the authorization server 102 of FIG. 5). In this example, a host virtualization agent (e.g., the host virtualization agent 708 of FIG. 5) intercepts the authorization request 206. This interception can be accomplished using any combination of a variety of techniques including, for example, code injection via a browser helper object (BHO)/extension to a browser executing, or embedded within, the hosted application; utilization of one or more hooks within the hosted application; registration of the host virtualization agent as a URI scheme handler of authorization requests; and/or scripting of a proxy server for the hosted application. Details describing these techniques are articulated in further detail above with reference to the operation 402 of FIG. 4.

Continuing the process 800, the host virtualization agent generates and transmits a browser instantiation request 802 to a local virtualization agent (e.g., the local virtualization agent 712 of FIG. 5). By requesting instantiation of a new embedded browser instance, the process 800 helps establish an increased level of control and security over some other implementations. The local virtualization agent receives and transmits the browser instantiation request 802 to a virtual workspace client (e.g., the virtual workspace client 714 of FIG. 5) executing locally to the local virtualization agent. In response to reception of the browser instantiation request 802, the virtual workspace client instantiates a new instance of an embedded browser (e.g., the embedded browser 710 of FIG. 5).

Continuing the process 800, the host virtualization agent passes the intercepted authorization request 206 to the embedded browser via the local virtualization agent and the virtual workspace client. For instance, in some examples, the host virtualization agent passes the intercepted authorization request 206 to the local virtualization agent. In these examples, the local virtualization agent receives the authorization request 206 and passes it the virtual workspace client. The virtual workspace client receives the authorization request 206, instantiates the embedded browser, and passes the authorization request 206 to the embedded browser.

Continuing the process 800, the embedded browser receives and processes the authorization request 206 by interoperating with the authorization server to robustly authenticate a user of the hosted application to the authorization server as an owner of the protected resource subject to the original resource request 202. The interoperations between the embedded browser and the authorization server include exchanges of the authorization request 206, the authentication challenge 208, the authentication response 210, and the authorization response 212 described above with reference to FIG. 2.

Continuing the process 800, the embedded browser passes the authorization response 212 to the host virtualization agent. The host virtualization agent receives the authorization response 212 and generates and transmits a browser termination request 804 to the local virtualization agent. The local virtualization agent receives and transmits the browser termination request 804 to the virtual workspace client. In response to reception of the browser termination request 804, the virtual workspace client terminates the embedded browser. Next, the host virtualization agent passes the authorization response 212 to the hosted application. The hosted application processes the authorization response 212 and interoperates with the resource server to access the protected resources at the originally requested scope via a token included in the authorization response 212. The interoperations between the hosted application and the resource server include exchanges of the resource request 214 and the resource response 216 described above with reference to FIG. 2. Upon completion of the LAVA process 800, the hosted application can access the protected resources for subsequent processing.

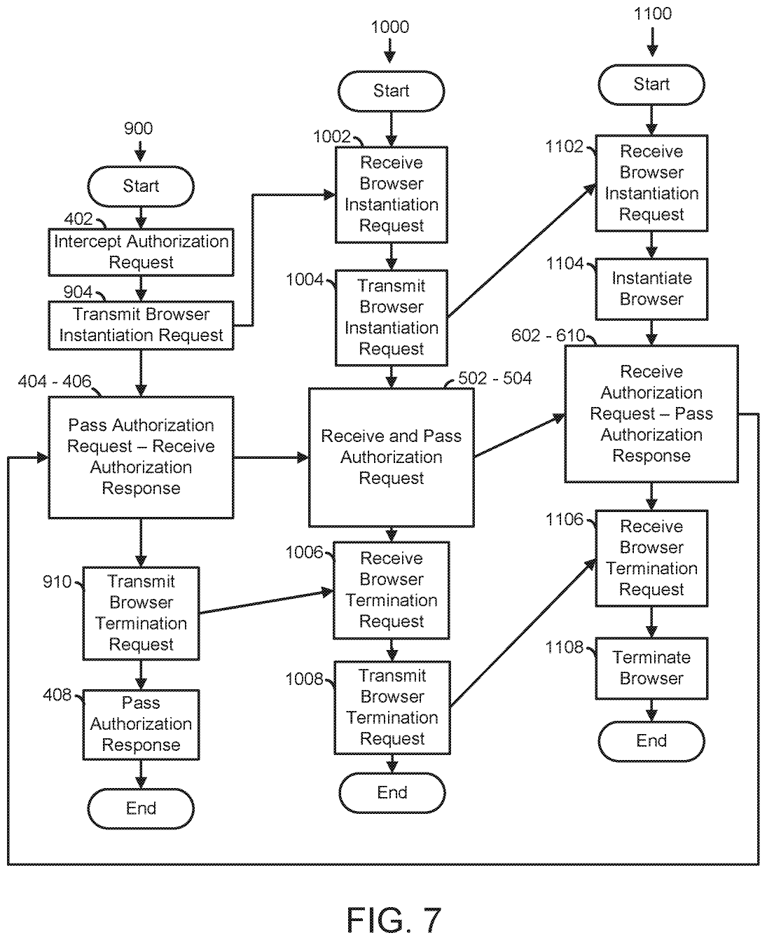

FIG. 7 is a combined flow diagram that illustrates three related processes 900, 1000, and 1100 useful to implement an overall LAVA process, such as the LAVA process 800 described above with reference to FIG. 6. The processes 900, 1000, and 1100 can be respectively executed by a host virtualization agent (e.g., the host virtualization agent 708 of FIG. 5), a local virtualization agent (e.g., the local virtualization agent 712 of FIG. 5), and a virtual workspace client with an embedded browser (e.g., the virtual workspace client 714 and the embedded browser 710 of FIG. 1). Some of the operations illustrated in FIG. 7 are described above with reference to FIG. 4. For purposes of brevity, those descriptions will not be repeated here, but each of these operations within the processes 900, 1000, and 1100 includes actions analogous to those of the corresponding operation within the processes 400, 500, and 600. The description of any of the operations of the processes 900, 1000, and 1100 may be augmented or refined below.

As shown in FIG. 7, the process 900 starts with the host virtualization agent intercepting 402 an authorization request from a hosted application (e.g., the hosted application 106 of FIG. 5) to an authorization server (e.g., the authorization server 102 of FIG. 5). Next, the host virtualization agent transmits 904 a browser instantiation request to the local virtualization agent. The host virtualization agent passes 404 the intercepted authorization request to the local virtualization agent and receives 406 an authorization response from the embedded browser. The host virtualization agent transmits 910 a browser termination request to the local virtualization agent. The host virtualization agent passes 408 the authorization response to the hosted application (e.g., by transmitting a message including the authorization response to the hosted application), and the process 900 ends.

As shown in FIG. 7, the process 1000 starts with the local virtualization agent receiving 1002 the browser instantiation request from the host virtualization agent. Next, the local virtualization agent transmits 1004 the browser instantiation request to the virtual workspace client. The local virtualization agent next receives 502 the authorization request and passes 504 the authorization request from the host virtualization agent to the embedded browser. The local virtualization agent receives 1006 and transmits 1008 the browser termination request from the host virtualization agent to the virtual workspace client, and the process 1000 ends.

As shown in FIG. 7, the process 1100 starts with the virtual workspace client receiving 1102 the browser instantiation request from the local virtualization agent. Next, the virtual workspace client instantiates 1104 the embedded browser. The embedded browser receives 602 the authorization request, interoperates 604, 608 with the authorization server to authenticate 606 a user of the hosted application as an owner of protected resources subject to the authorization request, and passes 610 an authorization response received from the authorization server to the host virtualization agent. Next, the virtual workspace client receives 1106 the browser termination request from the local virtualization agent, terminates 1108 the embedded browser, and the process 1100 ends.

LAVA System with Browser Content Redirection

In some examples, the LAVA system 700 of FIG. 5 is configured to intercept and redirect authorization messages (e.g., authorization requests and authorization responses) using BCR. BCR enables a seamless user experience due in large part to the fact that the local browser used to authenticate the user is embedded within a virtual workspace client that is native to the virtualization infrastructure of the endpoint device.

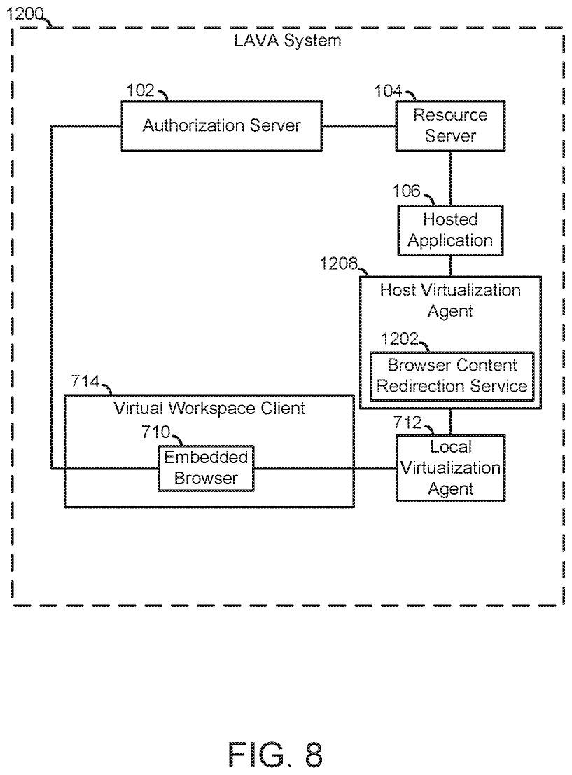

FIG. 8 illustrates a logical architecture of a LAVA system 1200 in accordance with some examples disclosed herein that utilize BCR. As shown in FIG. 8, the LAVA system 1200 includes the authorization server 102, the resource server 104, and the hosted application 106 of FIG. 1. The LAVA system 1200 also includes the virtual workspace client 714, the embedded browser 710, and the local virtualization agent 712 of FIG. 5. Within the LAVA system 1200, the host virtualization agent 1208 descends from and inherits the attributes of the host virtualization agent 708 of FIG. 5. By virtue of its inheritance, the host virtualization agent 1208 can execute the processes executable by its ancestors. The host virtualization agent 1208 is further configured to support BCR and includes a browser content redirection service 1202, which is commercially available from Citrix Systems. Some of the computer-implemented processes illustrated in FIG. 8 are described above with reference to FIGS. 1 and 5. For purposes of brevity, those descriptions will not be repeated here, but each of these processes is configured to operate within the LAVA system 1200 as each is configured to operate within the LAVA systems 100 and 700 of FIGS. 1 and 5. The description of any of the computer-implemented processes of the LAVA system 1200 may be augmented or refined below. FIG. 8 also illustrates lines of communication between these computer-implemented processes. Details regarding these communications are provided below, but it should be noted that the depicted lines of communication can include inter-process communication (e.g., where two or more of the computer-implemented processes illustrated in FIG. 8 reside within the same execution environment) and network-based communication (e.g., where two or more of the processes reside in different execution environments coupled to one another by a computer network).

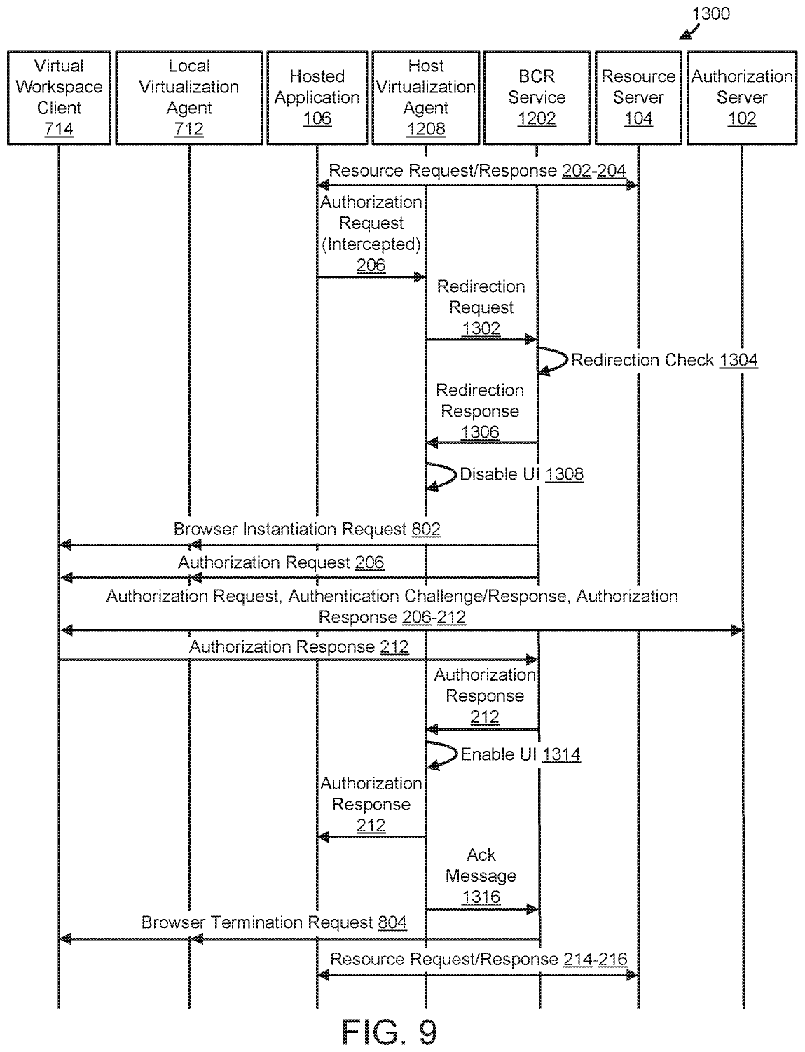

FIG. 9 is a sequence diagram that illustrates one example of a successfully executed LAVA process 1300. As shown in FIG. 9, the process 1300 includes interoperations between the computer-implemented processes illustrated in FIG. 8 that collectively accomplish robust authentication of a user within an authorization workflow. Some of the operations illustrated in FIG. 9 are described above with reference to FIGS. 2 and 6. For purposes of brevity, those descriptions will not be repeated here, but each of these operations within the process 1300 includes actions analogous to those of the corresponding operation within the processes 200 and 800. The description of any of the operations of the process 1300 may be augmented or refined below.

The process 1300 starts with a hosted application (e.g., the hosted application 106 of FIG. 8) and a resource server 104 (e.g., the resource server 104 of FIG. 8) interoperating with one another to exchange and process the resource request/response pair 202-204 described above with reference to FIG. 2. Further, in this example, the hosted application generates and attempts to transmit the authorization request 206 described above with reference to FIG. 2 to an authorization server (e.g., the authorization server 102 of FIG. 8). In this example, a host virtualization agent (e.g., the host virtualization agent 1208 of FIG. 8) intercepts the authorization request 206. This interception can be accomplished using any combination of a variety of techniques including, for example, code injection via a browser helper object (BHO)/extension to a browser executing, or embedded within, the hosted application; utilization of one or more hooks within the hosted application; registration of the host virtualization agent as a URI scheme handler of authorization requests; and/or scripting of a proxy server for the hosted application. Details describing these techniques are articulated in further detail above with reference to the operation 402 of FIG. 4.

Continuing the process 1300, the host virtualization agent passes the intercepted authorization request 206 to a BCR service (e.g., the browser content redirection service 1202 of FIG. 8) by generating and transmitting a redirection request 1302 to the BCR service. The redirection request 1302 can include the intercepted authorization request 206. The BCR service receives the redirection request 1302 and executes a redirection check 1304 of redirection policies maintained by the BCR service to determine whether the URI within the authorization request 206 is content that is subject to redirection via BCR. The BCR service generates and transmits a redirection response 1306 to the host virtualization agent. The redirection response 1306 can include an indication of whether the authorization request 206 is subject to BCR. Where, as in this example, the BCR service determines as a result of the redirection check 1304 that the intercepted authorization request is subject to BCR, the BCR service generates and transmits the browser instantiation request 802 to a local virtualization agent (e.g., the local virtualization agent 712 of FIG. 8) and passes the intercepted authorization request 206 to the local virtualization agent.

Continuing the process 1300, the host virtualization agent receives the redirection response 1306 and parses the redirection response 1306 to determine whether the URI identified in the previously transmitted, associated redirection request 1302 is subject to BCR. Where, as in this example, the host virtualization agent determines that the previously identified URI is subject to BCR, the host virtualization agent disables 1308 the user interface (UI) of the hosted application.

Continuing the process 1300, the local virtualization agent receives and transmits the browser instantiation request 802 from the BCR service and to a virtual workspace client (e.g., the virtual workspace client 714 of FIG. 8) executing locally to the local virtualization agent. The local virtualization agent also receives the authorization request 206 and passes the authorization request 206 from the BCR service and to an embedded browser (e.g., the embedded browser 710 of FIG. 8) via the virtual workspace client.

Continuing the process 1300, in response to reception of the browser instantiation request 802, the virtual workspace client instantiates a new instance of the embedded browser. The embedded browser receives and processes the authorization request 206 and interoperates with the authorization server to robustly authenticate a user of the hosted application to the authorization server as an owner of the protected resource subject to the original resource request 202. The interoperations between the embedded browser and the authorization server include exchanges of the authorization request 206, the authentication challenge 208, the authentication response 210, and the authorization response 212 described above with reference to FIG. 2.

Continuing the process 1300, the embedded browser passes the authorization response 212 to the BCR service. The BCR service receives the authorization response 212 and passes the authorization response 212 to the host virtualization agent. The host virtualization agent receives the authorization response 212 and enables 1314 the UI of the hosted application. The host virtualization agent also passes the authorization response 212 to the hosted application and transmits an acknowledgment message 1316 to the BCR service. The hosted application receives the authorization response 212. The BCR service receives the acknowledgment message 1316 and generates and transmits a browser termination request 804 to the local virtualization agent. The local virtualization agent receives and transmits the browser termination request 804 to the virtual workspace client. In response to reception of the browser termination request 804, the virtual workspace client terminates the embedded browser.

Continuing the process 1300, the hosted application processes the authorization response 212 and interoperates with the resource server to access the protected resources at the originally requested scope via a token included in the authorization response 212. The interoperations between the hosted application and the resource server include exchanges of the resource request 214 and the resource response 216 described above with reference to FIG. 2. Upon completion of the LAVA process 1300, the hosted application can access the protected resources for subsequent processing.

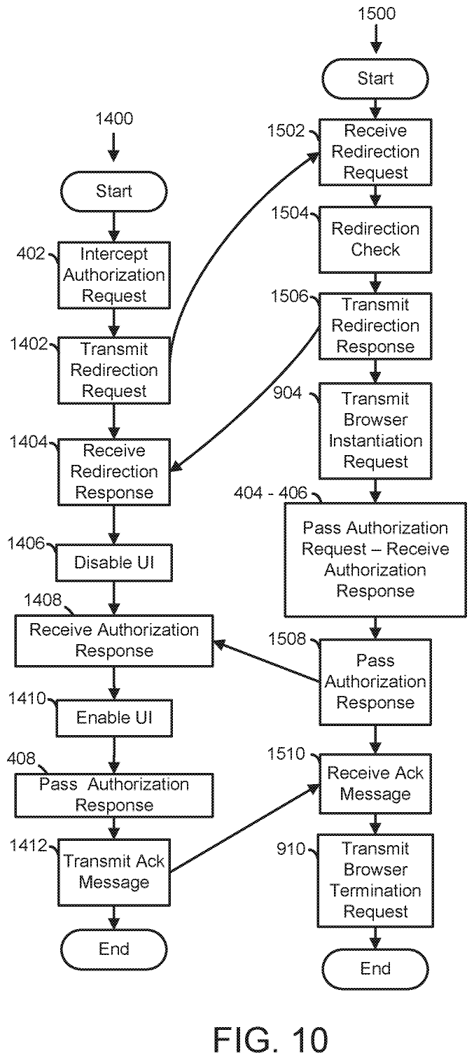

FIG. 10 is a combined flow diagram that illustrates two related processes 1400 and 1500 useful to implement an overall LAVA process, such as the LAVA process 1300 described above with reference to FIG. 9. The processes 1400 and 1500 can be respectively executed by a host virtualization agent (e.g., the host virtualization agent 1208 of FIG. 8) and a BCR service (e.g., the browser content redirection service 1202 of FIG. 8). Some of the operations illustrated in FIG. 10 are described above with reference to FIGS. 4 and 7. For purposes of brevity, those descriptions will not be repeated here, but each of these operations within the processes 1400 and 1500 includes actions analogous to those of the corresponding operation within the processes 400 and 900. The description of any of the operations of the processes 1400 and 1500 may be augmented or refined below.

As shown in FIG. 10, the process 1400 starts with the host virtualization agent intercepting 402 an authorization request from a hosted application (e.g., the hosted application 106 of FIG. 8) to an authorization server (e.g., the authorization server 102 of FIG. 8). Next, the host virtualization agent transmits 1402 a redirection request to the BCR service. Where, as in this example, the host virtualization agent receives 1404 a redirection response from the BCR service that indicates the intercepted authorization request is subject to BCR, the host virtualization agent disables 1406 the UI of the hosted application. The host virtualization agent next receives 1408 an authorization response from the BCR service, enables 1410 the UI of the hosted application, and passes 408 the authorization response to the hosted application. Next, the host virtualization agent transmits 1412 an acknowledgement message, and the process 1400 ends.

As shown in FIG. 10, the process 1500 starts with the BCR service receiving 1502 a redirection request including the authorization request from the host virtualization agent. The BCR service checks 1504 the BCR policies to determine whether the authorization request is subject to BCR. The BCR service transmits 1506 a redirection response to the host virtualization agent that indicates whether the authorization request is subject to BCR. Where, as in this example, the authorization request is subject to BCR, the BCR service transmits 904 a browser instantiation request to a local virtualization agent (e.g., the local virtualization agent 712 of FIG. 8). Next, the BCR service passes 404 the authorization request to the local virtualization agent and receives 406 an authorization response from an embedded browser (e.g., the embedded browser 710 of FIG. 8). The BCR service passes 1508 the authorization response to the host virtualization agent. The BCR service also receives 1510 an acknowledgement message from the host virtualization agent. Next, the BCR service transmits 910 a browser termination request to the local virtualization agent, which in turn transmits the browser termination request to the embedded browser, and the process 1500 ends.

In some examples that utilize BCR, the BCR service implements and exposes an API with calls that accept authorization requests and respond with authorization responses. In these examples, in response to reception of an authorization request via the API from a calling process, the BCR service executes that operations 1506, 904, and 404-406 of the process 1500. Rather than next executing the operation 1508, the BCR service passes the authorization response to the calling process. In these examples, a hosted application can orchestrate OAuth workflows purposefully by interoperating with the BCR service via the API.

In some examples, that utilize BCR, the hosted application and/or a browser native to the OS executing within the virtual computing session includes hooks that, when enabled, detect and intercept authorization requests. In these examples, the hooks can interact with the API exposed by the BCR service, as described above, to orchestrate OAuth workflows. Alternatively or additionally, in some examples, the hooks execute a helper application to orchestrate OAuth workflows. It should be noted that the BCR API described above can obviate the need for JavaScript injection, although this is not a requirement.

LAVA System with One or More Browser Helper Objects/Extension/Hooks

In some examples, the LAVA system 100 of FIG. 1 is configured to intercept and redirect authorization messages using one or more BHOs/extensions/hooks. Unlike some approaches to interception and redirection, use of one or more BHOs/extensions/hooks does not require specialized whitelisting at the authorization server. In addition BHOs/extensions/hooks enable parallel processing of multiple concurrent authorization workflows (e.g., by utilizing multiple browser containers/tabs).

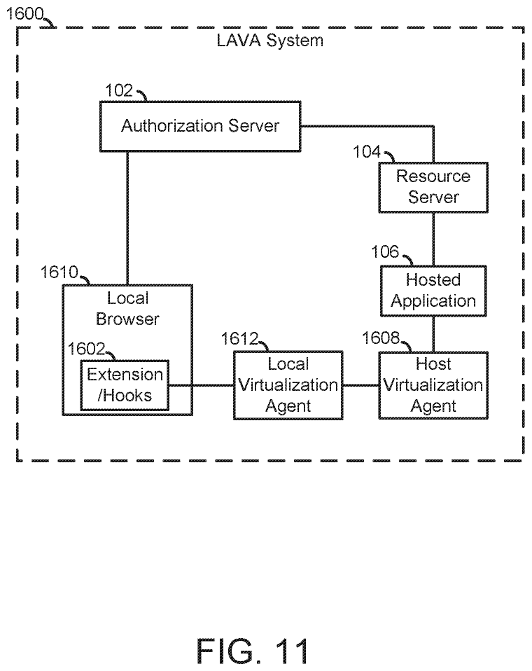

FIG. 11 illustrates a logical architecture of a LAVA system 1600 in accordance with some examples disclosed herein that utilize one or more BHOs/extensions/hooks. As shown in FIG. 11, the LAVA system 1600 includes the authorization server 102, the resource server 104, and the hosted application 106 of FIG. 1. Within the LAVA system 1600, the local virtualization agent 1612 descends from and inherits the attributes of the local virtualization agent 112 of FIG. 1. The host virtualization agent 1608 descends from and inherits the attributes of the host virtualization agent 108 of FIG. 1. The local browser 1610 descends from and inherits the attributes of the local browser 110 of FIG. 1. By virtue of their inheritance, each of the local browser 1610, the host virtualization agent 1608, and the local virtualization agent 1612 can execute the processes executable by its ancestors. In addition, the local browser 1610 includes one or more BHOs/extensions/hooks 1602 configured to support LAVA processing. Some of the computer-implemented processes illustrated in FIG. 11 are described above with reference to FIG. 1. For purposes of brevity, those descriptions will not be repeated here, but each of these processes is configured to operate within the LAVA system 1600 as each is configured to operate within the LAVA system 100 of FIG. 1. The description of any of the computer-implemented processes of the LAVA system 1600 may be augmented or refined below. FIG. 11 also illustrates lines of communication between these computer-implemented processes. Details regarding these communications are provided below, but it should be noted that the depicted lines of communication can include inter-process communication (e.g., where two or more of the computer-implemented processes illustrated in FIG. 11 reside within the same execution environment) and network-based communication (e.g., where two or more of the processes reside in different execution environments coupled to one another by a computer network).

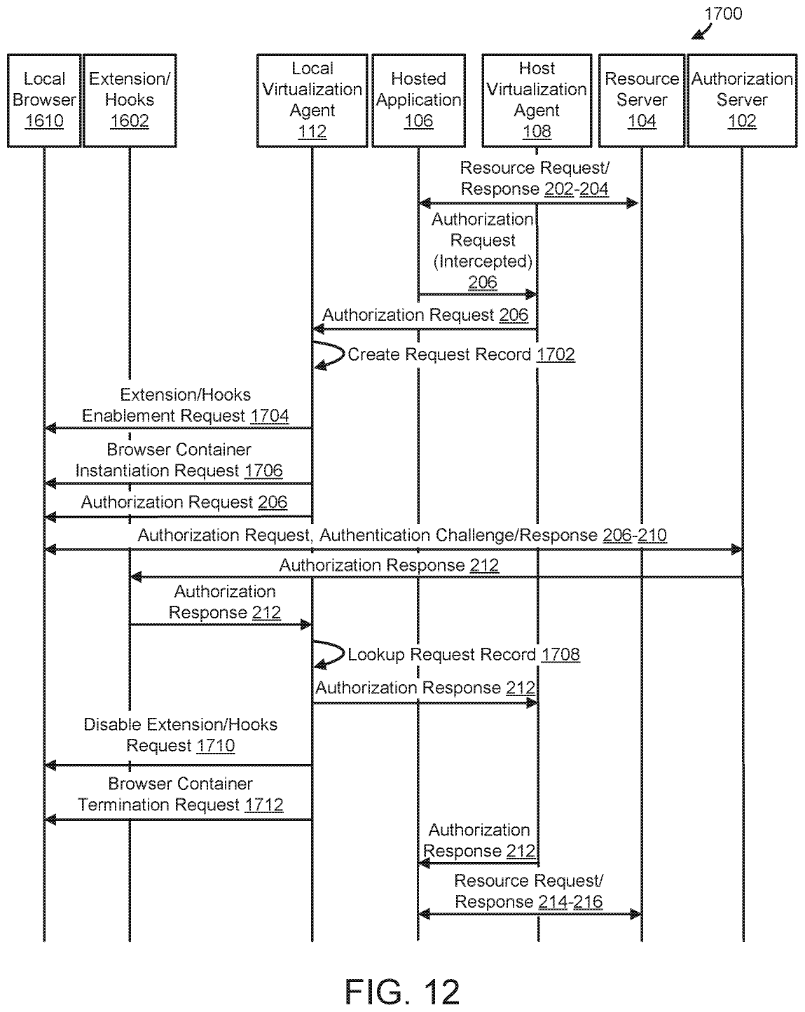

FIG. 12 is a sequence diagram that illustrates one example of a successfully executed LAVA process 1700. As shown in FIG. 12, the process 1700 includes interoperations between the computer-implemented processes illustrated in FIG. 11 that collectively accomplish robust authentication of a user within an authorization workflow. Some of the operations illustrated in FIG. 12 are described above with reference to FIG. 2. For purposes of brevity, those descriptions will not be repeated here, but each of these operations within the process 1700 includes actions analogous to those of the corresponding operation within the process 200. The description of any of the operations of the process 1700 may be augmented or refined below.

The process 1700 starts with a hosted application (e.g., the hosted application 106 of FIG. 11) and a resource server 104 (e.g., the resource server 104 of FIG. 11) interoperating with one another to exchange and process the resource request/response pair 202-204 described above with reference to FIG. 2. Further, in this example, the hosted application generates and attempts to transmit the authorization request 206 described above with reference to FIG. 2 to an authorization server (e.g., the authorization server 102 of FIG. 11). In this example, a host virtualization agent (e.g., the host virtualization agent 1608 of FIG. 11) intercepts the authorization request 206 and passes the intercepted authorization request 206 to a local virtualization agent (e.g., the local virtualization agent 1612 of FIG. 11). This interception can be accomplished using any combination of a variety of techniques including, for example, code injection via a browser helper object (BHO)/extension to a browser executing, or embedded within, the hosted application; utilization of one or more hooks within the hosted application; registration of the host virtualization agent as a URI scheme handler of authorization requests; and/or scripting of a proxy server for the hosted application. In some examples, the one or more BHOs/extensions/hooks can monitor for authorization responses being loaded by the extended/hooked browser and prevent completion of the load as part of intercepting the authorization response. In some examples, the load of the authorization response is completed as part of intercepting the authorization response. Details describing interception techniques are articulated in further detail above with reference to the operation 402 of FIG. 4.

Continuing the process 1700, the local virtualization agent receives the authorization request 206 and creates 1702 a request record. The request record can include, for example, an identifier of the authorization request, a copy of the URI included in the authorization request (including the contents of the redirect_uri parameter), a timestamp indicating the time at which the authorization request was received by the local virtualization agent, and an identifier of the virtual computing session in which the hosted application and host virtualization agent are running, among other information. The local virtualization agent generates and transmits an enablement request 1704 to a browser (e.g., the local browser 1610) executing locally to the local virtualization agent. The enablement request 1704 instructs the local browser to enable one or more LAVA BHOs/extensions/hooks (e.g., the one or more BHOs/extensions/hooks 1602 of FIG. 11). The local virtualization agent also generates and transmits a container instantiation request 1706 to the local browser and passes the authorization request 206 to the local browser. The container instantiation request can include, for example, the identifier of the authorization request included within the request record previously generated by the local virtualization agent. Additionally, the local virtualization agent passes the authorization request 206 to the local browser. In some examples, prior to passing the authorization request 206 to the local browser, the local virtualization agent stores a copy of the value stored in the state parameter of the authorization request 206 within the request record and alters the value stored in the state parameter to equal the request identifier in the request record.

Continuing the process 1700, in response to reception of the container instantiation request 1706, the local browser instantiates a container associated with the request identifier included in the container instantiation request. The container can be, for example, a new tab. The local browser receives and processes (e.g., within the new tab) the authorization request 206 and interoperates with the authorization server to robustly authenticate a user of the hosted application to the authorization server as an owner of the protected resource subject to the original resource request 202. The interoperations between the local browser and the authorization server include exchanges of the authorization request 206, the authentication challenge 208, and the authentication response 210 described above with reference to FIG. 2.

Continuing the process 1700, the one or more LAVA BHOs/extensions/hooks monitor responses received by the local browser, intercept the authorization response 212, and pass the authorization response 212 to the local virtualization agent within a message that includes the request identifier associated with the container used to authenticate the user. The local virtualization agent receives the intercepted authorization response 212, looks up 1708 the request record containing the request identifier, and passes the authorization response 212 to the host virtualization agent executing within the virtual computing session identified in the request record containing the request identifier. It should be noted that the look up 1708 can be based upon the request identifier included in the message or upon the value of the state and/or redirect_uri parameter in the authorization response 212. In examples that base the look up 1708 on the value of the state parameter, the local virtualization agent replaces the value of the state parameter in the authorization response with the copy of the value previously stored in the request record.

Continuing the process 1700, the local virtualization agent generates and transmits a disablement request 1710 to the local browser. The disablement request 1710 instructs the local browser to disable the one or more LAVA BHOs/extensions/hooks. The local virtualization agent also generates and transmits a container termination request 1712 to the local browser.

Continuing the process 1700, the hosted application processes the authorization response 212 and interoperates with the resource server to access the protected resources at the originally requested scope via a token included in the authorization response 212. The interoperations between the hosted application and the resource server include exchanges of the resource request 214 and the resource response 216 described above with reference to FIG. 2. Upon completion of the LAVA process 1700, the hosted application can access the protected resources for subsequent processing.

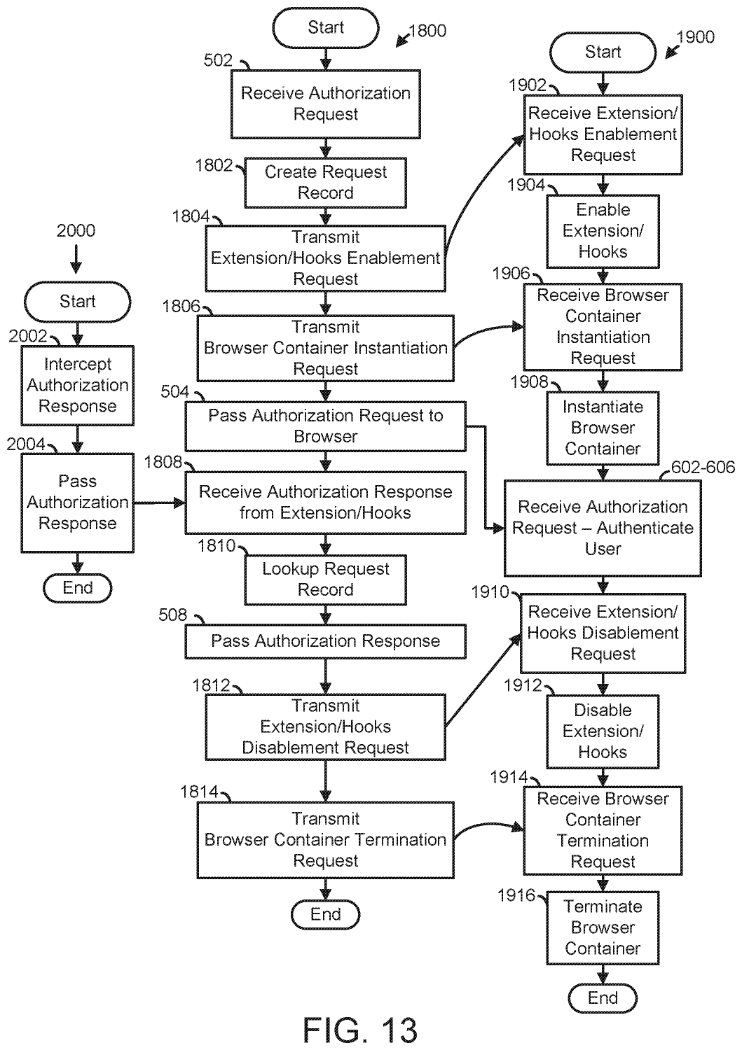

FIG. 13 is a combined flow diagram that illustrates three related processes 1800, 1900, and 2000 useful to implement an overall LAVA process, such as the LAVA process 1700 described above with reference to FIG. 12. The processes 1800, 1900, and 2000 can be respectively executed by a local virtualization agent (e.g., the local virtualization agent 1612 of FIG. 11), a local browser (e.g., the local browser 1610 of FIG. 11), and one or more LAVA BHOs/extensions/hooks (e.g., the one or more BHOs/extensions/hooks 1602 of FIG. 11). Some of the operations illustrated in FIG. 13 are described above with reference to FIG. 4. For purposes of brevity, those descriptions will not be repeated here, but each of these operations within the processes 1800 and 1900 includes actions analogous to those of the corresponding operation within the processes 500 and 600. The description of any of the operations of the processes 1800, 1900, and 2000 may be augmented or refined below.

As shown in FIG. 13, the process 1800 starts with the local virtualization agent receiving 502 the authorization request from the host virtualization agent. Next, the local virtualization agent creates 1802 a request record. The request record can include, for example, an identifier of the authorization request, a copy of the URI included in the authorization request (including the contents of the redirect_uri parameter), a tirnestamp indicating the time at which the authorization request was received by the local virtualization agent, and an identifier of the virtual computing session in which the hosted application and host virtualization agent are running, among other information. The local virtualization agent generates and transmits 1804 an enablement request to the local browser. The local virtualization agent generates and transmits 1806 a container instantiation request to the local browser. The container instantiation request can include a request identifier. The local virtualization agent passes 504 the authorization request to the local browser. As part of passing 504, the local virtualization agent can store a copy of the value of the state and/or redirect_uri parameter of the authorization request in the request record. Also as part of passing 504, the local virtualization agent can replace the value of the state parameter in the authorization response with a value that equals the value of the request identifier in the request record. The local virtualization agent receives 1808 an authorization response and an associated request identifier from the one or more LAVA BHOs/extensions/hooks. The local virtualization agent looks up 1810 a request record having a request identifier that matches the request identifier received from the one or more LAVA BHOs/extensions/hooks or the value of state and/or redirect_uri parameter of the authorization response. The local virtualization agent passes 508 the authorization response to the host virtualization agent currently executing within the virtual computing session identified in the request record with the request identifier that matches the associated request identifier. As part of passing 508 the authorization response, the local virtualization agent can replace the value of the state parameter in the authorization response with a copy of the value of the state parameter stored in the request record. The local virtualization agent generates and transmits 1812 a disablement request to the local browser. The local virtualization agent generates and transmits 1814 a container termination request to the local browser, and the process 1800 ends.

As shown in FIG. 13, the process 1900 starts with the local browser receiving 1902 the enablement request from the local virtualization agent. Next, the local browser enables 1904 the one or more LAVA BHOs/extensions/hooks. The local browser receives 1906 the container instantiation request and instantiates 1908 a browser container (e.g., tab). The local browser stores an association between a request identifier included in the container instantiation request and the browser container for subsequent reference. The local browser receives 602 the authorization request, interoperates 604 with the authorization server to authenticate 606 a user of the hosted application as an owner of protected resources subject to the authorization request. The local browser receives 1910 a disablement request from the local virtualization agent. In response to reception of the disablement request, the local browser disables 1912 the one or more LAVA BHOs/extensions/hooks. The local browser receives 1914 a container termination request from the local virtualization agent. In response to reception of the container termination request, the local browser terminates 1916 the container, and the process 1900 ends.

As shown in FIG. 13, the process 2000 starts with the one or more LAVA BHOs/extensions/hooks monitoring responses to the local browser and intercepting 2002 the authorization response. Next, one or more LAVA BHOs/extensions/hooks pass 2004 the authorization response to the local virtualization agent, along with a request identifier maintained in association with the tab to which the authorization response was addressed. Subsequent to the execution of operation 2004, the process 2000 ends.

It should be noted that the one or more BHOs/extensions/hooks can be implemented using a variety of techniques. For instance, in some examples, the one or more BHOs/extensions/hooks extend Internet Explorer, Edge, Firefox, and Chrome browsers. Alternatively or additionally, in some examples, the one or more BHOs/extensions/hooks include hooks set on the ShellExecute family of Win32 API calls and/or hooks set on the DOM browser API calls. In either case, these hooks can be setup using Mfaphook.dll, an API hooking DLL part of the HDX™ virtualization infrastructure commercially available from Citrix Systems, and associated settings in the Windows registry.

Within examples that implement the one or more BHOs/extensions/hooks, the request identifier described above can be uniquely associated with a tab in the extended/hooked browser. In these examples, the one or more BHOs/extensions/hooks access this association to identify a process (e.g., virtual computing session or local application) that should be passed an authorization response returned to the tab.

LAVA System with URI Scheme Handler

In some examples, the LAVA system 100 of FIG. 1 is configured to intercept and redirect authorization messages using URI scheme handlers. Unlike some approaches to interception and redirection, use of a URI scheme handler does not require specialized whitelisting at the authorization server.

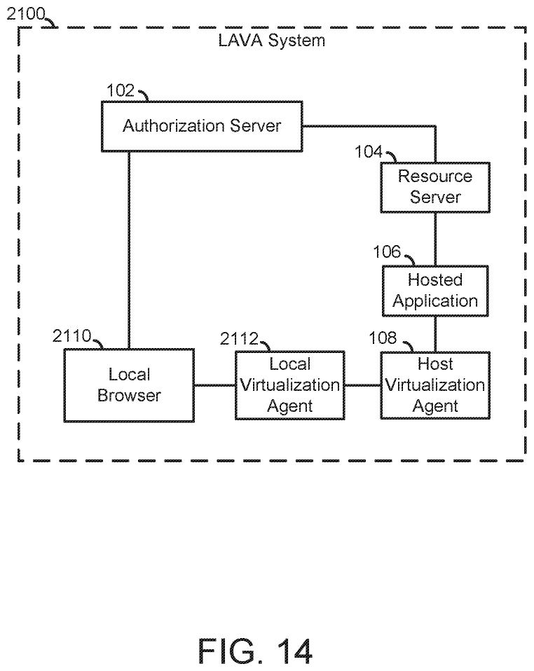

FIG. 14 illustrates a logical architecture of a LAVA system 2100 in accordance with some examples disclosed herein that utilize URI scheme handlers. As shown in FIG. 14, the LAVA system 2100 includes the authorization server 102, the resource server 104, the hosted application 106, and the host virtualization agent 108 of FIG. 1. Within the LAVA system 2100, the local virtualization agent 2112 descends from and inherits the attributes of the local virtualization agent 1612 of FIG. 11. The local browser 2110 descends from and inherits the attributes of the local browser 110 of FIG. 1. By virtue of their inheritance, each of the local browser 2110 and the local virtualization agent 2112 can execute the processes executable by its ancestors. Some of the computer-implemented processes illustrated in FIG. 14 are described above with reference to FIG. 1. For purposes of brevity, those descriptions will not be repeated here, but each of these processes is configured to operate within the LAVA system 2100 as each is configured to operate within the LAVA systems 100 of FIG. 1. The description of any of the computer-implemented processes of the LAVA system 2100 may be augmented or refined below. FIG. 14 also illustrates lines of communication between these computer-implemented processes. Details regarding these communications are provided below, but it should be noted that the depicted lines of communication can include inter-process communication (e.g., where two or more of the computer-implemented processes illustrated in FIG. 14 reside within the same execution environment) and network-based communication (e.g., where two or more of the processes reside in different execution environments coupled to one another by a computer network).

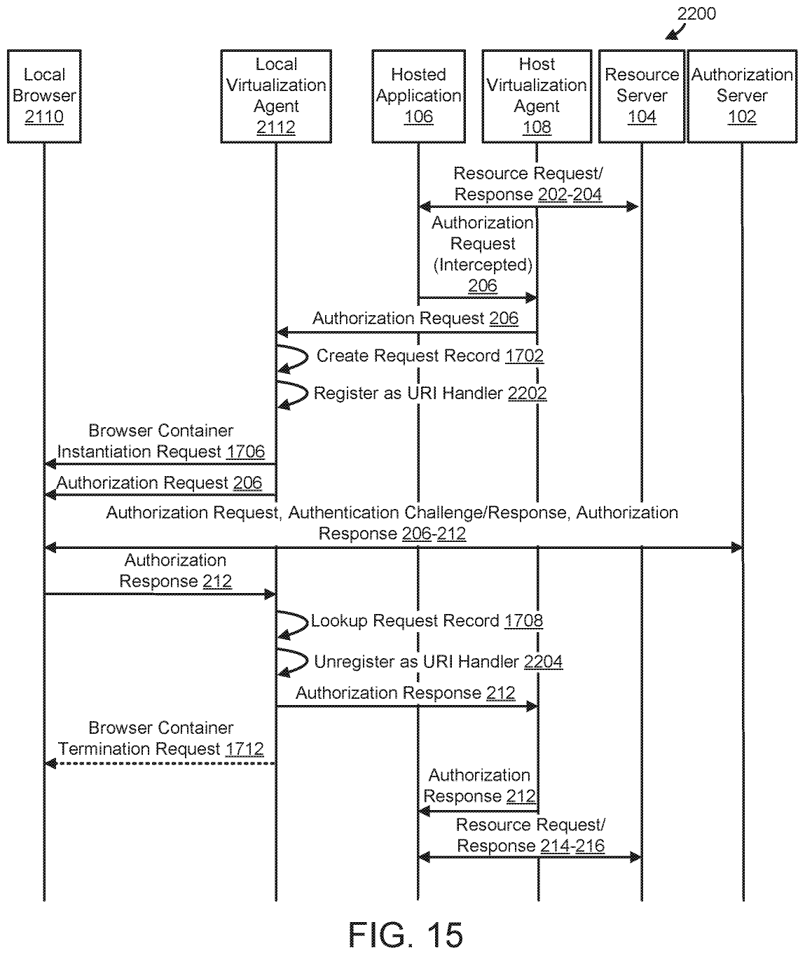

FIG. 15 is a sequence diagram that illustrates one example of a successfully executed LAVA process 2200. As shown in FIG. 15, the process 2200 includes interoperations between the computer-implemented processes illustrated in FIG. 14 that collectively accomplish robust authentication of a user within an authorization workflow. Some of the operations illustrated in FIG. 15 are described above with reference to FIGS. 2 and 12. For purposes of brevity, those descriptions will not be repeated here, but each of these operations within the process 2200 includes actions analogous to those of the corresponding operation within the processes 200 and 1700. The description of any of the operations of the process 2200 may be augmented or refined below.

The process 2200 starts with a hosted application (e.g., the hosted application 106 of FIG. 14) and a resource server 104 (e.g., the resource server 104 of FIG. 14) interoperating with one another to exchange and process the resource request/response pair 202-204 described above with reference to FIG. 2. Further, in this example, the hosted application generates and attempts to transmit the authorization request 206 described above with reference to FIG. 2 to an authorization server (e.g., the authorization server 102 of FIG. 14). In this example, a host virtualization agent (e.g., the host virtualization agent 108 of FIG. 14) intercepts the authorization request 206 and passes the intercepted authorization request 206 to a local virtualization agent (e.g., the local virtualization agent 2112 of FIG. 14). This interception can be accomplished using any combination of a variety of techniques including, for example, code injection via a browser helper object (BHO)/extension to a browser executing, or embedded within, the hosted application; utilization of one or more hooks within the hosted application; registration of the host virtualization agent as a URI scheme handler of authorization requests; and/or scripting of a proxy server for the hosted application. Details describing these techniques are articulated in further detail above with reference to the operation 402 of FIG. 4.

Continuing the process 2200, the local virtualization agent receives the authorization request 206 and creates 1702 a request record. The request record can include, for example, an identifier of the authorization request, a copy of the URI included in the authorization request, a timestamp indicating the time at which the authorization request was received by the local virtualization agent, and an identifier of the virtual computing session in which the hosted application and host virtualization agent are running, among other information. The local virtualization agent also registers 2202, with an OS executing on the endpoint that is executing the local virtualization agent, as a URI scheme handler for URIs that are to be included in authorization responses received from the authorization server. As these URIs are specified by the hosted application in the value of the redirect_uri parameter of the authorization request, the local virtualization agent can retrieve the value of the redirect_uri parameter from the authorization request and register itself as the handler for the upper level of the URI. For example, where the redirect_uri=“acme-my-app %3A%2F%2Fauth” the local virtualization agent can register itself as the URI scheme handler for “acme-my-app://”.

Continuing the process 2200, the local virtualization agent generates and transmits a container instantiation request 1706 to a browser (e.g., the local browser 2110 of FIG. 14) executing on the same endpoint device as the local virtualization agent and passes the authorization request 206 to the local browser. The container instantiation request can include, for example, the identifier of the authorization request included within the request record previously generated by the local virtualization agent.

Continuing the process 2200, in response to reception of the container instantiation request 1706, the local browser instantiates a container. The container can be, for example, a new tab. For subsequent reference, the local browser stores an association between the contain and the request identifier included in the container instantiation request. The local browser receives and processes (e.g., within the new tab) the authorization request 206 and interoperates with the authorization server to robustly authenticate a user of the hosted application to the authorization server as an owner of the protected resource subject to the original resource request 202. The interoperations between the embedded browser and the authorization server include exchanges of the authorization request 206, the authentication challenge 208, the authentication response 210, and the authorization response 212 described above with reference to FIG. 2.

Continuing the process 2200, when the local browser processes the authorization response 212, the OS identifies the local virtualization agent as a registered URI scheme handler for the authorization response 212 and transmits a copy of the authorization response 212 to the local virtualization agent. The local virtualization agent receives the authorization response 212 and looks up 1708 the request record containing the request identifier equal to the value stored in the state and/or redirect_uri parameter of the authorization response 212. Further, the local virtualization agent replaces the value of the state parameter with the value stored in the request record, unregisters 2204 itself as URI scheme handler for authorization responses, and passes the authorization response 212 to the host virtualization agent executing within the virtual computing session identified in the request record. The local virtualization agent also optionally generates and transmits a container termination request 1712 to the local browser.

Continuing the process 2200, the host virtualization agent receives the authorization response 212 and passes the authorization response 212 to the hosted application. The hosted application receives the authorization response 212 and interoperates with the resource server to access the protected resources at the originally requested scope via a token included in the authorization response 212. The interoperations between the hosted application and the resource server include exchanges of the resource request 214 and the resource response 216 described above with reference to FIG. 2. Upon completion of the LAVA process 2200, the hosted application can access the protected resources for subsequent processing.

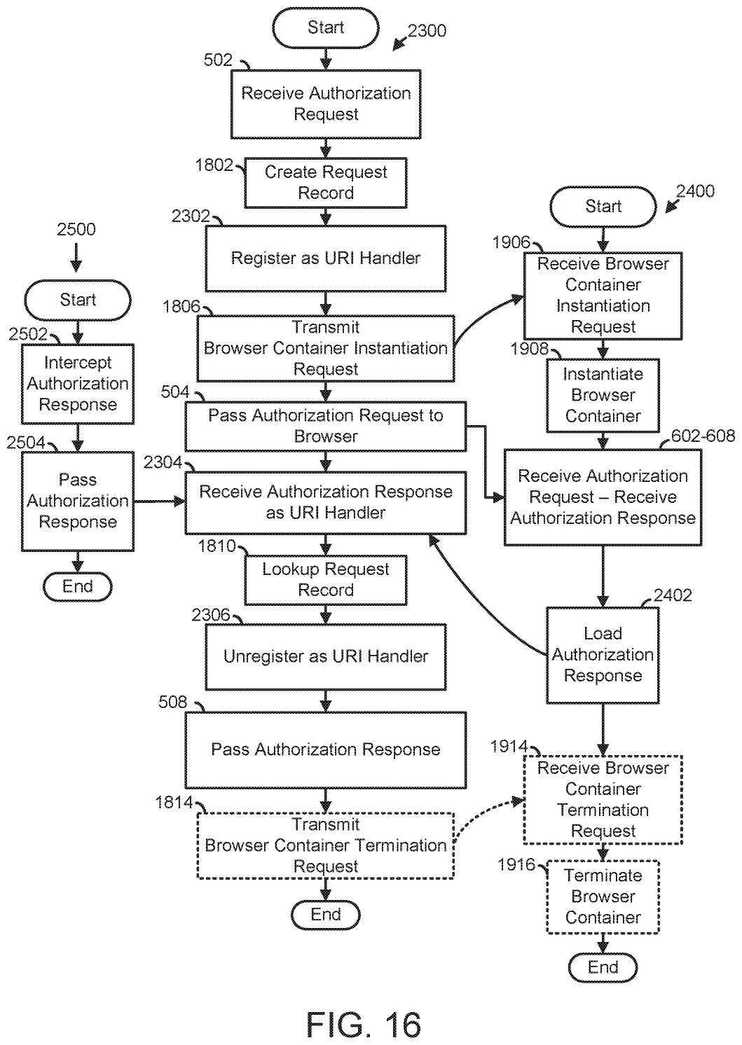

FIG. 16 is a combined flow diagram that illustrates three related processes 2300, 2400, and 2500 useful to implement an overall LAVA process, such as the LAVA process 2200 described above with reference to FIG. 15. The processes 2300, 2400, and 2500 can be respectively executed by a local virtualization agent (e.g., the local virtualization agent 2112 of FIG. 14), a local browser (e.g., the local browser 2110 of FIG. 14), and the OS of the endpoint device executing the local virtualization agent. Some of the operations illustrated in FIG. 16 are described above with reference to FIGS. 4 and 13. For purposes of brevity, those descriptions will not be repeated here, but each of these operations within the processes 2300 and 2400 includes actions analogous to those of the corresponding operation within the processes 500, 600, 1800, and 1900. The description of any of the operations of the processes 2300, 2400, and 2500 may be augmented or refined below.

As shown in FIG. 16, the process 2300 starts with the local virtualization agent receiving 502 the authorization request from the host virtualization agent. Next, the local virtualization agent creates 1802 a request record. The local virtualization agent registers 2302 as a URI scheme handler for authorization responses. For instance, where the redirect_uri parameter of the authorization request=“acme-my-app%3A%2F%2Fauth” the local virtualization agent can register itself as the URI scheme handler for “acme-my-app://”. The local virtualization agent generates and transmits 1806 a container instantiation request to the local browser. The local virtualization agent passes 504 the authorization request to the local browser. As part of passing 504, the local virtualization agent can store a copy of the value of the state and/or redirect_uri parameter of the authorization request in the request record. Also as part of passing 504, the local virtualization agent can replace the value of the state parameter in the authorization response with a value that equals the value of the request identifier in the request record. The local virtualization agent receives 2304 an authorization response from the OS due to its registration as the URI scheme handler of authorization responses. The local virtualization agent looks up 1810 a request record having a request identifier that matches the value of the state and/or redirect_uri parameter in the authorization response. The local virtualization agent unregisters 2306 itself as URI scheme handler for authorization responses. The local virtualization agent passes 508 the authorization response to the host virtualization agent currently executing within the virtual computing session identified in the request record with the request identifier that matches the associated request identifier. As part of passing 508 the authorization response, the local virtualization agent replaces the value of the state parameter in the authorization response with a copy of the value of the state parameter stored in the request record. The local virtualization agent optionally generates and transmits 1814 a container termination request to the local browser, and the process 2300 ends.

As shown in FIG. 16, the process 2400 starts with the local browser receiving 1906 the container instantiation request. In response to reception of the container instantiation request, the local browser instantiates 1908 a browser container (e.g., tab). The local browser stores, for subsequent reference, an association between the container and a request identifier included in the container instantiation request. The local browser receives 602 the authorization request, interoperates 604, 608 with the authorization server to authenticate 606 a user of the hosted application as an owner of protected resources subject to the authorization request. The local browser loads 2402 the authorization response, thereby causing the OS to invoke any URI scheme handlers registered to handle authorization responses (e.g., the local virtualization agent). The local browser optionally receives 1914 a container termination request from the local virtualization agent. In response to reception of the container termination request, the local browser terminates 1916 the container, and the process 2400 ends.

As shown in FIG. 16, the process 2500 starts with the OS monitoring URIs accessed by the local browser and intercepting 2502 the authorization response upon its being accessed by the local browser. Next, the OS passes 2504 the authorization response to the local virtualization agent, as a registered URI scheme handler of authorization response URIs and, the process 2500 ends.

It should be noted that the examples of the LAVA system with URI scheme handling described above benefit from registering the local virtualization agent as URI scheme handler. For instance, by using this approach, the local virtualization agent does not require endpoint device management authority. Moreover, by registering on a per authorization request basis, the local virtualization agent decreases the likelihood of a URI registration collision with other local applications. It should be noted, however, that in some examples, the local virtualization agent can detect a URI registration collision. In those examples, the local virtualization agent unregisters itself and calls, for example, a ShellExecute function to pass handling to the next URI scheme handler.

To further illustrate a LAVA system with a URI scheme handler as described above with reference to FIGS. 14-16, an example of a particular configuration follows. Within this example, an authorization server (e.g., the authorization server 102 of FIG. 14) stores a whitelist that includes entries that identify client applications. These client applications are registered with the authorization server and able to interoperate with the authorization server to obtain tokens to access resources protected by a resource server (e.g., the resource server 104 of FIG. 14). These interoperations can occur, for example, within an authorization process (e.g., an OAuth 2.0 workflow as described by RFC 6749 and/or RFC 8252). In this example, the whitelist includes an entry for an application (e.g., the hosted application 106 of FIG. 14) hosted within a virtual computing session. This entry includes a field storing the URI “acme-my-app://auth”.

In this example, the hosted application, or its installer, registers the hosted application as a handler of the URI scheme “acme-my-app://”, thereby creating an association between the URI scheme and the hosted application. This registration can be made with the OS of the virtual computing session. Further, in this example, a host virtualization agent (e.g., the host virtualization agent 108 of FIG. 14) sets hooks (e.g., via Mfaphook.dll on the DOM browser API calls) to intercept (e.g., the operation 402 of FIG. 4) authorization requests that the hosted application attempts to transmit to the authorization server. These hooks monitor for URI that match a pattern indicative of authorization requests, as expressed using the regular expression “https://login.acme.com/oauth2_login?*&redirect_uri=acme-my-app%3A%2F%2Fa uth.*”. Further, these hooks pass intercepted authorization requests to a local virtualization agent (e.g., the local virtualization agent 2112 of FIG. 14) executing under a local OS of an endpoint device associated with a user of the hosted application.

Continuing this example, to initiate an authorization process, the hosted application transmits (e.g., the operation 310 of FIG. 3) an authorization request including the URI “https://login.acme.com/oauth2_login?action=auth&client=12345&redirect_uri=acme-my-app %3A%2F%2Fauth”. As this URI matches the regular expression being monitored by the host virtualization agent (via its hooks), the host virtualization agent intercepts (e.g., the operation 402 of FIG. 4) the authorization request and passes (e.g., the operation 404 of FIG. 4) the authorization request to the local virtualization agent. It should be noted that if the hosted application transmits a URI that does not match the pattern being monitored by the host virtualization agent (e.g., a URI with the same login provider, but a different resource), the URI will not be intercepted but will instead operate as originally designed. One example of a URI that would not be intercepted in this example is “https://login.acme.com/oauth2_login?action=auth &client=12345&redirect_uri=https%3A%2F%2Fwww.acme.com employee_portal”.

Continuing this example, the local virtualization agent receives (e.g., the operation 502 of FIG. 16) the authorization request from the host virtualization agent. The local virtualization agent registers (e.g., the operation 2302 of FIG. 16) as the URI scheme handler for the authorization response that will result from the received authorization request. The local virtualization agent can base its URI scheme handler registration on a hardcoded URI scheme or on a URI scheme extracted from the received authorization requests (e.g., a URI scheme extracted from and based on the redirect_uri parameter of the authorization requests). Where, as in this example, the authorization request includes a URI that falls within the regular expression “https://login.acme.com/oauth2_login?.*&redirect_uri=acme-my-app%3A%2F%2Fa uth.*”, the local virtualization agent can extract the URI scheme “acme--my-app://” from the authorization request and can register itself with the OS running on the endpoint device as the URI scheme handler for “acme-my-app://”.

Continuing this example, the local virtualization agent creates (e.g., the operation 1802 of FIG. 16) a request record that stores an identifier of the virtual computing session that originated the authorization request and a copy of the authorization request. Next, the local virtualization agent passes (e.g., the operation 504 of FIG. 16) the authorization request to a local browser (e.g., the local browser 2110 of FIG. 14) executing on the endpoint device. The local browser receives the authorization request, transmits the authorization request to the authorization server, authenticates the user, and receives an authorization response from the authorization server (e.g., the operations 602-608 of FIG. 16). The authorization response can include a redirect URI including a token or an error parameter. In this example, the redirect URI includes a token. More specifically, the redirect URI is “acme-my-app://auth?login=successful&t oken=abcdefg12345”.

Continuing this example, the local browser loads (e.g., the operation 2402 of FIG. 16) the redirect URI of the authorization response. In this example, the local virtualization agent intercepts (e.g., by operations 2502 and 2504 of the OS illustrated in FIG. 16) the authorization response due to its registration as the URI scheme handler of “acme-my-app://”. The local virtualization agent receives (e.g., the operation 2304 of FIG. 16) the authorization response. The local virtualization agent looks up (e.g., the operation 1810 of FIG. 16) the request record corresponding to the authorization response (e.g., by comparing the redirect_uri parameter in the request record to the redirect URI of the authorization response, or by comparing other data in the request record to data in the authorization response) and passes (e.g., the operation 508 of FIG. 16) the authorization response to the host virtualization agent. It should be noted that, in some examples, if the local virtualization agent cannot find an outstanding request record matching the authorization response, the local virtualization agent can pass 508 the authorization response to a previously-registered (“fallback”) handler for this scheme. This feature is helpful in remedying URI scheme handler collisions (e.g., where the hosted application is running locally on the endpoint device).

Continuing this example, the local virtualization agent unregisters (e.g., the operation 2306 of FIG. 16) as the URI scheme handler for authorization responses and deletes the looked-up request record. Back in the virtual computing session, the host virtualization agent opens the authorization response. This causes the hosted application to intercept and receive (e.g., the operation 312 of FIG. 3) the authorization response due to its registration as the URI scheme handler of “acme-my-app://” with the OS of the virtual computing session. The hosted application next accesses (e.g. operations 302-308 of FIG. 3) the protected resources using the token in the authorization response.

LAVA System with URI Rewriter

In some examples, the LAVA system 100 of FIG. 1 is configured to intercept and redirect authorization messages using URI rewriting. For instance, a callback parameter of an authorization request can be rewritten to direct an authorization server to communicate with the virtualization infrastructure, rather than an originally targeted process. Unlike some approaches to interception and redirection, this approach enables parallel processing of multiple authorization requests.

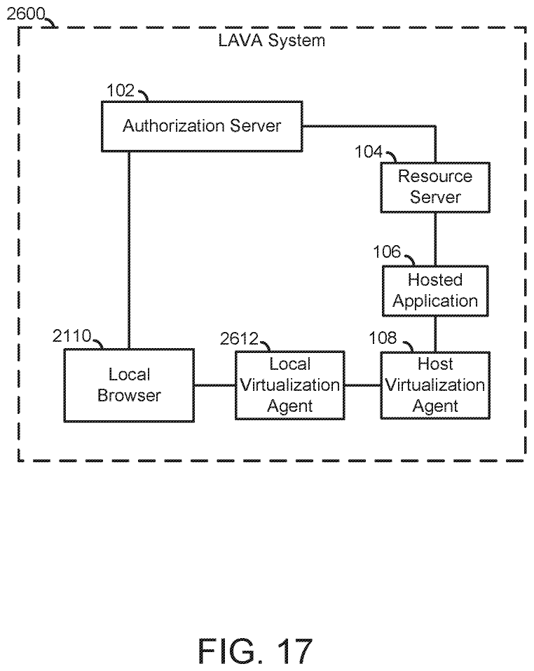

FIG. 17 illustrates a logical architecture of a LAVA system 2600 in accordance with some examples disclosed herein that utilize URI rewriting. As shown in FIG. 17, the LAVA system 2600 includes the authorization server 102, the resource server 104, the hosted application 1.06, and the host virtualization agent 108 of FIG. 1. The LAVA system 2600 also includes the local browser 2110 of FIG. 14. Within the LAVA system 2600, the local virtualization agent 2612 descends from and inherits the attributes of the local virtualization agent 2112 of FIG. 14. By virtue of its inheritance, the local virtualization agent 2612 can execute the processes executable by its ancestors. Some of the computer-implemented processes illustrated in FIG. 17 are described above with reference to FIGS. 1 and 14. For purposes of brevity, those descriptions will not be repeated here, but each of these processes is configured to operate within the LAVA system 2600 as each is configured to operate within the LAVA systems 100 and 2100 of FIGS. 1 and 14. The description of any of the computer-implemented processes of the LAVA system 2600 may be augmented or refined below. FIG. 17 also illustrates lines of communication between these computer-implemented processes. Details regarding these communications are provided below, but it should be noted that the depicted lines of communication can include inter-process communication (e.g., where two or more of the computer-implemented processes illustrated in FIG. 17 reside within the same execution environment) and network-based communication (e.g., where two or more of the processes reside in different execution environments coupled to one another by a computer network),

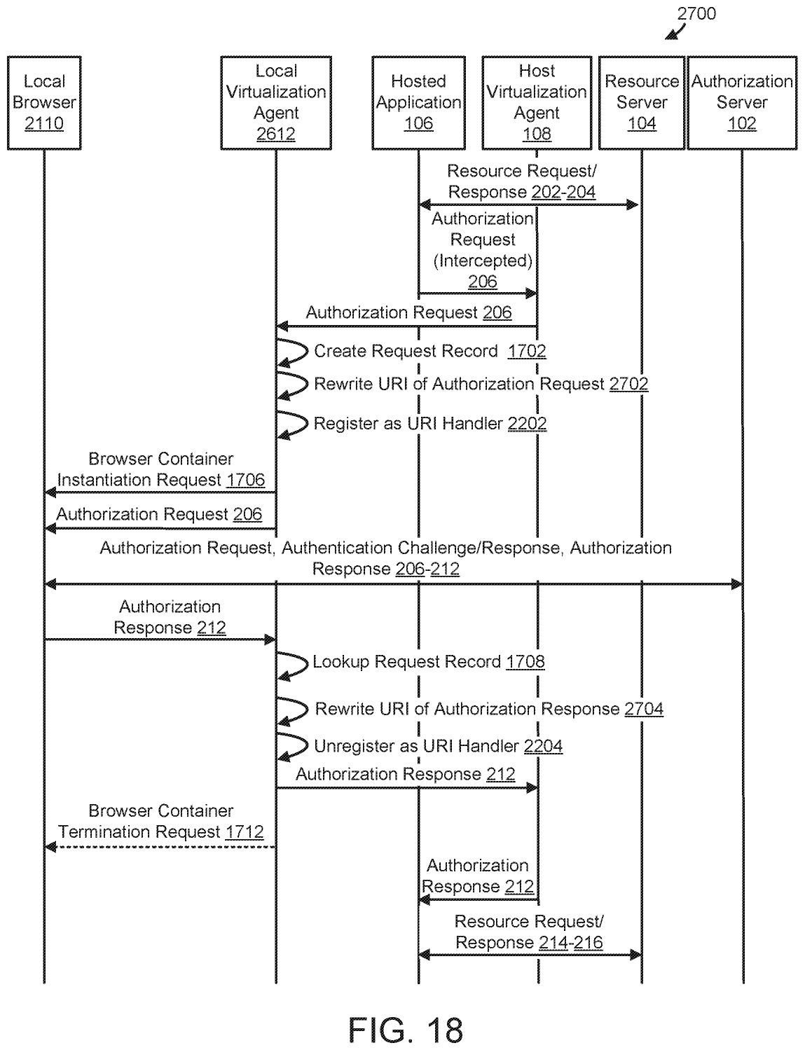

FIG. 18 is a sequence diagram that illustrates one example of a successfully executed LAVA process 2700. As shown in FIG. 18, the process 2700 includes interoperations between the computer-implemented processes illustrated in FIG. 17 that collectively accomplish robust authentication of a user within an authorization workflow. Some of the operations illustrated in FIG. 18 are described above with reference to FIGS. 2 and 15. For purposes of brevity, those descriptions will not be repeated here, but each of these operations within the process 2700 includes actions analogous to those of the corresponding operation within the processes 200 and 2200. The description of any of the operations of the process 2700 may be augmented or refined below.

The process 2700 starts with a hosted application (e.g., the hosted application 106 of FIG. 17) and a resource server 104 (e.g., the resource server 104 of FIG. 17) interoperating with one another to exchange and process the resource request/response pair 202-204 described above with reference to FIG. 2. Further, in this example, the hosted application generates and attempts to transmit the authorization request 206 described above with reference to FIG. 2 to an authorization server (e.g., the authorization server 102 of FIG. 17). In this example, a host virtualization agent (e.g., the host virtualization agent 108 of FIG. 17) intercepts the authorization request 206 and passes the intercepted authorization request 206 to a local virtualization agent (e.g., the local virtualization agent 2612 of FIG. 17). This interception can be accomplished using any combination of a variety of techniques including, for example, code injection via a browser helper object (BHO)/extension to a browser executing, or embedded within, the hosted application; utilization of one or more hooks within the hosted application; registration of the host virtualization agent as a URI scheme handler of authorization requests; and/or scripting of a proxy server for the hosted application. Details describing these techniques are articulated in further detail above with reference to the operation 402 of FIG. 4.

Continuing the process 2700, the local virtualization agent receives the authorization request 206 and creates 1702 a request record. The request record can include, for example, an identifier of the authorization request, a copy of the URI included in the authorization request, a timestamp indicating the time at which the authorization request was received by the local virtualization agent, and an identifier of the virtual computing session in which the hosted application and host virtualization agent are running, among other information. The local virtualization agent also rewrites 2702 the URI of the intercepted authorization request 206. More specially, in some examples, the local virtualization agent substitutes references to the hosted application with references to the local virtualization agent within the redirect_uri parameter of the authorization request 206. These references to the local virtualization agent can include the identifier of authorization request included in the request record and/or an index that is temporarily associated, by the local virtualization agent, with the authorization request during its processing. The local virtualization agent also registers 2202, with an OS executing on the endpoint that is executing the local virtualization agent, as a URI scheme handler for URIs that are to be included in authorization responses received from the authorization server. Next, the local virtualization agent generates and transmits a container instantiation request 1706 to a browser (e.g., the local browser 2610 of FIG. 17) executing on the same endpoint device as the local virtualization agent and passes the authorization request 206 to the local browser. The container instantiation request can include, for example, the identifier of the authorization request included within the request record previously generated by the local virtualization agent and/or the index associated with the authorization request.

Continuing the process 2700, in response to reception of the container instantiation request 1706, the local browser instantiates a container associated with the request identifier or index included in the container instantiation request. The container can be, for example, a new tab. The local browser receives and processes (e.g., within the new tab) the authorization request 206 and interoperates with the authorization server to robustly authenticate a user of the hosted application to the authorization server as an owner of the protected resource subject to the original resource request 202. The interoperations between the embedded browser and the authorization server include exchanges of the authorization request 206, the authentication challenge 208, the authentication response 210, and the authorization response 212 described above with reference to FIG. 2. It should be noted that, due to the rewriting of the redirect_uri parameter of the authorization request, the authorization server may be required to deactivate whitelisting or to implement a specialized whitelist that accounts for the rewriting process implemented by the local virtualization agent. A detailed example of such a specialized whitelist is described below.

Continuing the process 2700, when the local browser processes the authorization response 212, the OS identifies the local virtualization agent as a registered URI scheme handler for the authorization response 212 and transmits a copy of the authorization response 212 to the local virtualization agent. The local virtualization agent receives the authorization response 212 and looks up 1708 the request record containing the request identifier equal to the value stored in the state and/or redirect_uri parameter of the authorization response 212. The local virtualization agent further replaces the value of the state parameter with the value stored in the request record, rewrites 2704 the URI of the authorization response 212 to substitute references to the local virtualization agent with references to the hosted application within the redirect_uri parameter, unregisters 2204 itself as URI scheme handler for authorization responses, and passes the authorization response 212 to the host virtualization agent executing within the virtual computing session identified in the request record. The local virtualization agent also optionally generates and transmits a container termination request 1712 to the local browser.

Continuing the process 2700, the host virtualization agent receives the authorization response 212 and passes the authorization response 212 to the hosted application. The hosted application receives the authorization response 212 and interoperates with the resource server to access the protected resources at the originally requested scope via a token included in the authorization response 212. The interoperations between the hosted application and the resource server include exchanges of the resource request 214 and the resource response 216 described above with reference to FIG. 2. Upon completion of the LAVA process 2700, the hosted application can access the protected resources for subsequent processing.

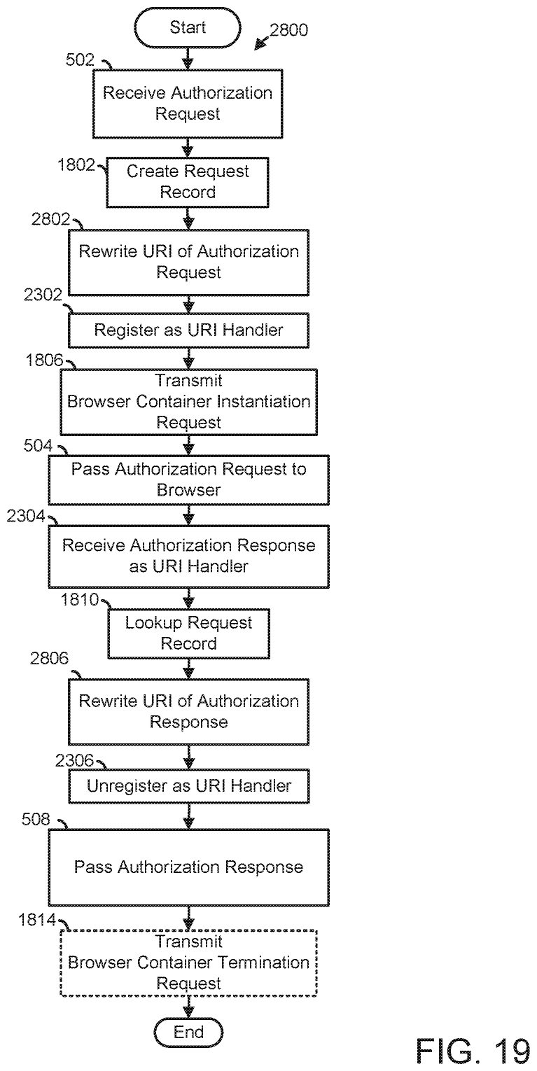

FIG. 19 is a flow diagram that illustrates a process 2800 useful to implement an overall LAVA process, such as the LAVA process 2700 described above with reference to FIG. 18. The process 2800 can be executed by a local virtualization agent (e.g., the local virtualization agent 2612 of FIG. 17). Some of the operations illustrated in FIG. 19 are described above with reference to FIGS. 4, 13, and 16. For purposes of brevity, those descriptions will not be repeated here, but each of these operations within the process 2800 includes actions analogous to those of the corresponding operation within the processes 500, 1800, and 2300. The description of any of the operations of the process 2800 may be augmented or refined below.

As shown in FIG. 19, the process 2300 starts with the local virtualization agent receiving 502 the authorization request from the host virtualization agent. Next, the local virtualization agent creates 1802 a request record. The local virtualization agent rewrites 2802 the URI of the authorization request to substitute references to the hosted application with references to the local virtualization agent within the redirect_uri parameter of the authorization request. The local virtualization agent registers 2302 as a URI scheme handler for authorization responses. The local virtualization agent generates and transmits 1806 a container instantiation request to the local browser. The local virtualization agent passes 504 the authorization request to the local browser. As part of passing 504, the local virtualization agent can store a copy of the value of the state and/or redirect_uri parameter of the authorization request in the request record. Also as part of passing 504, the local virtualization agent can replace the value of the state parameter in the authorization response with a value that equals the value of the request identifier in the request record. The local virtualization agent receives 2304 an authorization response from the OS due to its registration as the URI scheme handler of the rewritten URI. The local virtualization agent looks up 1810 a request record having a request identifier that matches the value of the state and/or redirect_uri parameter in the authorization response. The local virtualization agent rewrites 2806 the URI of the authorization response to substitute references to the local virtualization agent with references to the hosted application within the redirect_uri parameter of the authorization response. The local virtualization agent unregisters 2306 itself as URI scheme handler for authorization responses. The local virtualization agent passes 508 the authorization response to the host virtualization agent currently executing within the virtual computing session identified in the request record with the request identifier that matches the associated request identifier. As part of passing 508 the authorization response, the local virtualization agent replaces the value of the state parameter in the authorization response with a copy of the value of the state parameter stored in the request record. The local virtualization agent optionally generates and transmits 1814 a container termination request to the local browser, and the process 2300 ends.

To further illustrate a LAVA system with a URI rewriter as described above with reference to FIGS. 17-19, an example of a particular configuration follows. Within this example, an authorization server (e.g., the authorization server 102 of FIG. 17) stores a whitelist that includes entries that identify client applications and redirect URIs. These client applications and redirect URIs are registered with the authorization server and able to interoperate with the authorization server to obtain tokens to access resources protected by a resource server (e.g., the resource server 104 of FIG. 17). These interoperations can occur, for example, within an authorization process (e.g., an OAuth 2.0 workflow as described by RFC 6749 and/or RFC 8252). In this example, the whitelist includes an entry for an application (e.g., the hosted application 106 of FIG. 17) hosted within a virtual computing session. This entry includes a field storing the URI “https://www.acme.com/employee_portal”.

In some examples, the whitelist also includes entries to support URI rewriting by the local virtualization agent. These entries can vary between examples. For instance, where the local virtualization agent executes an index-based rewriting process, the whitelist includes the following entries—one for each index value: “citrix-oauth-redir://oauth2/1”; “citrix-oauth-redir://oauth2/2”; “citrix-oauth-redir://oauth2/ . . . ”; “citrix-oauth-redir://oauth2/N”. Alternatively or additionally, where the local virtualization agent executes an authorization-request-identifier-based method the whitelist includes the regular expression “citrix-oauth-redir://.*/https://www.acme.com/employee_portal”. Alternatively, the authorization server can deactivate whitelist functionality.

In this example, the hosted application, or its installer, registers the hosted application as a handler of the URI scheme “https://www.acme.com/employee_portal”, thereby creating an association between the URI scheme and the hosted application. This registration can be made with the OS of the virtual computing session. Further, in this example, a host virtualization agent (e.g., the host virtualization agent 108 of FIG. 17) sets hooks (e.g., via Mfaphook.dll on the DOM browser API calls) to intercept (e.g., the operation 402 of FIG. 4) authorization requests that the hosted application attempts to transmit to the authorization server. These hooks monitor for URI that match a pattern indicative of authorization requests, as expressed using the regular expression “https://login.acme.com/oauth2_login?.*&redirect_uri=\https://www.acme.com/employee_portal\).*”. Further, these hooks pass intercepted authorization requests to a local virtualization agent (e.g., the local virtualization agent 2112 of FIG. 17) executing under a local OS of an endpoint device of a user of the hosted application (e.g., an endpoint device that has authenticated the user)

Continuing this example, to initiate an authorization process, the hosted application transmits (e.g., the operation 310 of FIG. 3) an authorization request including the URI “https://login.acme.com/oauth2_login?action=auth&client=12345&redirect_uri=https%3A%2F %2Fwww.acme.com%2Femployee_portal”. As this URI matches the regular expression being monitored by the host virtualization agent (via its hooks), the host virtualization agent intercepts (e.g., the operation 402 of FIG. 4) the authorization request and passes (e.g., the operation 404 of FIG. 4) the authorization request to the local virtualization agent.

Continuing this example, the local virtualization agent receives (e.g., the operation 502 of FIG. 19) the authorization request from the host virtualization agent. The local virtualization agent creates (e.g., the operation 1802 of FIG. 19) a request record that stores an identifier of the virtual computing session that originated the authorization request and a copy of the authorization request, an identifier of the authorization request, and/or an index value associated with the authorization request. Next, the local virtualization agent rewrites the redirect_uri parameter of the authorization request to point to the local virtualization agent. Where the local virtualization agent uses an index-based rewriting method, the local virtualization agent identifies an unassigned index value, assigns the unused index value to the authorization request, and rewrites the redirect_uri parameter of the authorization request to indicate the assigned index value. For example, where the unassigned index value is 5, the local virtualization agent rewrites the redirect_uri parameter to “citrix-oauth-redir://oauth2/5”, thus resulting in the completely rewritten authorization request URI “https://login.acme.com/oauth2_login?action=auth&client=12345&redirect_uri=citrix-oauth-redir%3A%2F%2Foauth2%2F5”. Where the local virtualization agent uses an authorization-request-identifier-based method, the local virtualization agent rewrites the redirect_uri parameter of the authorization request to indicate the authorization request identifier. For example, where the authorization request identifier is 5678, the local virtualization agent rewrites the redirect_uri parameter to “citrix-oauth-redir://5678/https://www.acme.com/employee_portal”, resulting in the completely rewritten URI “https://login.acme.com/oauth2_login?action=auth&client=12345&redirect_uri=citrix-oauth-redir%3A%2F%2F5678%2Fhttps%3A%2F%2Fwww.acme.com%2Femployee_portal”.

Continuing this example, the local virtualization agent registers (e.g., the operation 2302 of FIG. 19) as the URI scheme handler for the authorization response that will result from the received authorization request. The local virtualization agent can base its URI scheme handler registration on a hardcoded URI scheme or on a URI scheme extracted from the received authorization requests (e.g., a URI scheme extracted from and based on the rewritten redirect_uri parameter of the authorization requests). In one example, the rewritten authorization request includes a URI that is index-based and that falls within a regular expression. In this example, “citrix-oauth-redir://oauth2/5” is the redirect URI and the regular expression pulls out of the following URI: “https://login.acme.com/oauth2_login?action=auth&client=12345&redirect_uri=citrix-oauth-redir%3A%2F%2Foauth2%2F5”. The local virtualization agent can extract the URI scheme “citrix-oauth-redir://oauth2/5” from the authorization request and can register itself with the OS running on the endpoint device as the URI scheme handler for “citrix-oauth-redir://oauth2/5”. Alternatively or additionally, in one example, the rewritten authorization request includes a URI that is authorization-request-identifier-based and falls within another regular expression. In this example, “citrix-oauth-redir://5678/https://www.acme.com/employee_portal” is the redirect URI and the regular expression pulls out of the following URI: “https://login.acme.com/oauth2_login?action=auth&client=12345&redirect_uri=citrix-oauth-redir%3A%2F%2F5678%2Fhttps%3A%2F%2Fwww.acme.com%2Femployee_portal” The local virtualization agent can extract the URI scheme “citrix-oauth-redir://5678” from the authorization request and can register itself with the OS running on the endpoint device as the URI scheme handler for “citrix-oauth-redir://5678”.

Continuing this example, the local virtualization agent passes (e.g., the operation 504 of FIG. 19) the authorization request to a local browser (e.g., the local browser 2110 of FIG. 17) executing on the endpoint device. The local browser receives the authorization request, transmits the authorization request to the authorization server, authenticates the user, and receives an authorization response from the authorization server (e.g., the operations 602-608 of FIG. 16). The authorization response can include a redirect URI including a token or an error parameter. In this example, the redirect URI is index-based and includes a token. More specifically, the redirect URI is “citrix-oauth-redir://oauth2/5?login=successful&token=abcdeig12345”. Where the redirect URI is authorization-request-identifier-based, the redirect URI is “citrix-oauth-redir://5678/https://www.acme.com/employee portal?login=successful&token=abcdefg12345”.

Continuing this example, the local browser loads (e.g., the operation 2402 of FIG. 16) the redirect URI of the authorization response. In this example, the local virtualization agent intercepts (e.g., by operations 2502 and 2504 of the OS illustrated in FIG. 16) the authorization response due to its registration as the URI scheme handler of “citrix-oauth-redir://oauth2/5” or “citrix-oauth-redir://5678”. The local virtualization agent receives (e.g., the operation 2304 of FIG. 19) the authorization response. The local virtualization agent looks up (e.g., the operation 1810 of FIG. 19) the request record corresponding to the authorization response (e.g., by comparing the redirect_{...}uri parameter in the request record to the redirect URI of the authorization response, or by comparing other data in the request record to data in the authorization response). The local virtualization agent rewrites (e.g., the operation 2806 of FIG. 19) the redirect URI in the authorization response to address the hosted application and passes (e.g., the operation 508 of FIG. 19) the authorization response to the host virtualization agent. It should be noted that no (“fallback”) handler is required in this system because authorization responses in need of rewriting have originated from the virtual computing session.

Continuing this example, the local virtualization agent unregisters (e.g., the operation 2306 of FIG. 16) as the URI scheme handler for authorization responses and deletes the looked-up request record. Back in the virtual computing session, the host virtualization agent opens the authorization response. This causes the hosted application to intercept and receive (e.g., the operation 312 of FIG. 3) the authorization response due to its registration as the URI scheme handler of “https://www.acme.com/employee_portal” with the OS of the virtual computing session. The hosted application next accesses (e.g. operations 302-308 of FIG. 3) the protected resources using the token in the authorization response.

It should be noted that, in examples where the URI scheme utilized is a dedicated scheme (e.g., “citrix-oauth-redir://”), repeated registration 2302 and un-registration 2306 is not required as URI scheme collision should not occur.

### Computing Devices for LAVA Systems

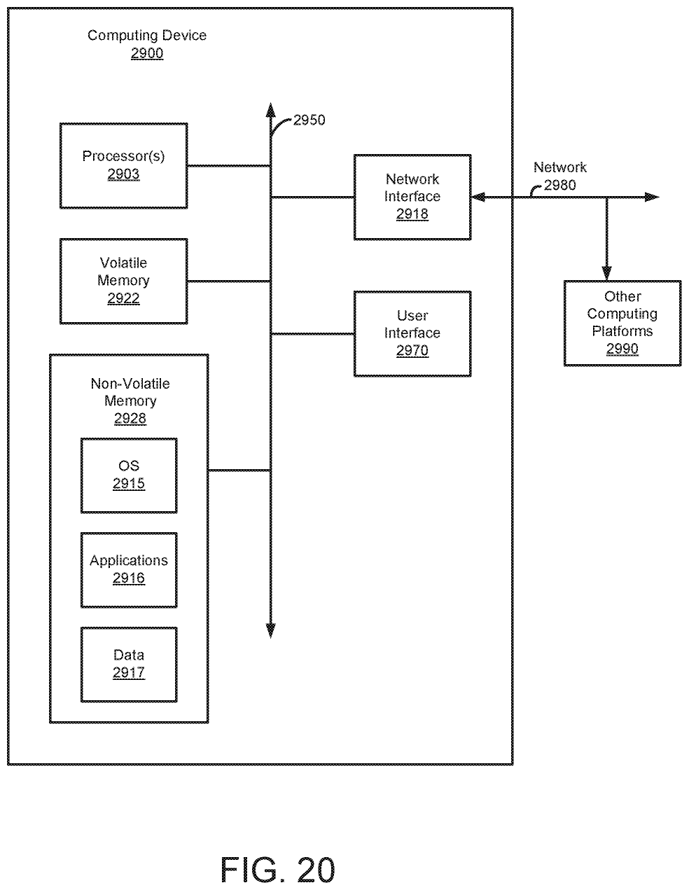

FIG. 20 is a block diagram of a computing device 2900 configured to implement various LAVA systems and processes in accordance with examples disclosed herein.

The computing device 2900 includes one or more processor(s) 2903, volatile memory 2922 (e.g., random access memory (RAM)), non-volatile memory 2928, a user interface (UI) 2970, one or more network or communication interfaces 2918, and a communications bus 2950. The computing device 2900 may also be referred to as a client device, computing device, endpoint device, computer, or a computer system.

The non-volatile (non-transitory) memory 2928 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 2970 can include a graphical user interface (GUI) (e.g., controls presented on a touchscreen, a display, etc.) and one or more input/output (I/O) devices (e.g., a mouse, a keyboard, a microphone, one or more speakers, one or more cameras, one or more biometric scanners, one or more environmental sensors, and one or more accelerometers, one or more visors, etc.)

The non-volatile memory 2928 stores an OS 2915, one or more applications or programs 2916, and data 2917. The OS 2915 and the application 2916 include sequences of instructions that are encoded for execution by processor(s) 2903. Execution of these instructions results in manipulated data. Prior to their execution, the instructions can be copied to the volatile memory 2922. In some examples, the volatile memory 2922 can include one or more types of RAM and/or a cache memory that can offer a faster response time than a main memory. Data can be entered through the user interface 2970 or received from the other I/O device(s), such as the network interface 2918. The various elements of the device 2900 described above can communicate with one another via the communications bus 2950.

The illustrated computing device 2900 is shown merely as an example client device or server and can be implemented within any computing or processing environment with any type of physical or virtual machine or set of physical and virtual machines that can have suitable hardware and/or software capable of operating as described herein.

The processor(s) 2903 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor(s) 2903 can be analog, digital or mixed. In some examples, the processor(s) 2903 can be one or more local physical processors or one or more remotely-located physical processors. A processor including multiple processor cores and/or multiple processors can provide functionality for parallel, simultaneous execution of instructions or for parallel, simultaneous execution of one instruction on more than one piece of data.

The network interfaces 2918 can include one or more interfaces to enable the computing device 2900 to access a computer network 2980 such as a Local Area Network (LAN), a Wide Area Network (WAN), a Personal Area Network (PAN), or the Internet through a variety of wired and/or wireless connections, including cellular connections and Bluetooth connections. In some examples, the network 2980 may allow for communication with other computing devices 2990, to enable distributed computing. The network 2980 can include, for example, one or more private and/or public networks over which computing devices can exchange data.

In described examples, the computing device 2900 can execute an application on behalf of a user of a client device. For example, the computing device 2900 can execute one or more virtual machines managed by a hypervisor. Each virtual machine can provide an execution session within which applications execute on behalf of a user or a client device, such as a hosted desktop session. The computing device 2900 can also execute a terminal services session to provide a hosted desktop environment. The computing device 2900 can provide access to a remote computing environment including one or more applications, one or more desktop applications, and one or more desktop sessions in which one or more applications can execute.

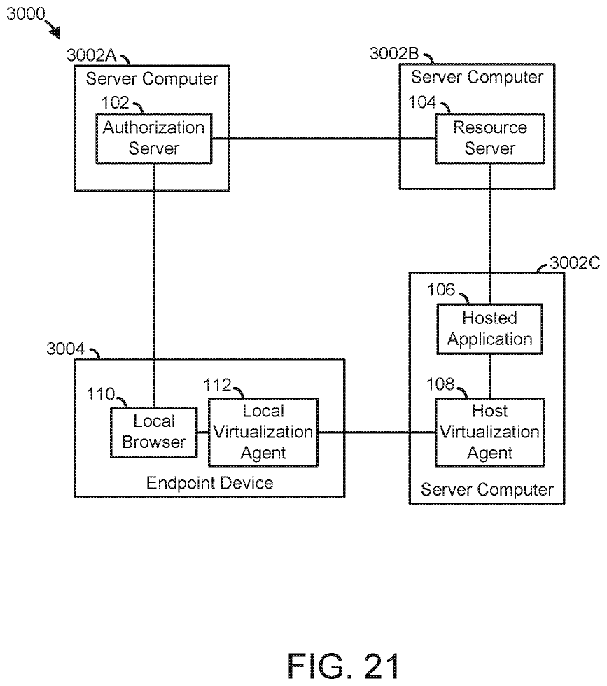

FIG. 21 illustrates a LAVA system (e.g., the LAVA system 100 of FIG. 1) configured for operation within a distributed computing system 3000 comprising computing devices (e.g. the computing device 2900 of FIG. 20). As shown in FIG. 21, the distributed computing system 3000 includes server computers 3002A-3002C that are configured to interoperate with one another and an endpoint device 3004 via a network. The network is illustrated by lines connecting the computing devices.

The server computer 3002A is configured to host the authorization server 102 of FIG. 1. The server computer 3002B is configured to host the resource server 104 of FIG. 1. The server computer 3002C is configured to host the hosted application 106 and the host virtualization agent 108 of FIG. 1. The endpoint device 3004 is configured to host the local browser 110 and the local virtualization agent 112 of FIG. 1. Examples of the endpoint device 3004 and the server computers 3002A-3002C include the computing device 2900 of FIG. 20.

The distributed computing system 3000 is but one example of many potential configurations that can be used to implement LAVA systems. As such, the examples disclosed herein are not limited to the particular configuration of computing devise and other configurations are considered to fall within the scope of this disclosure.

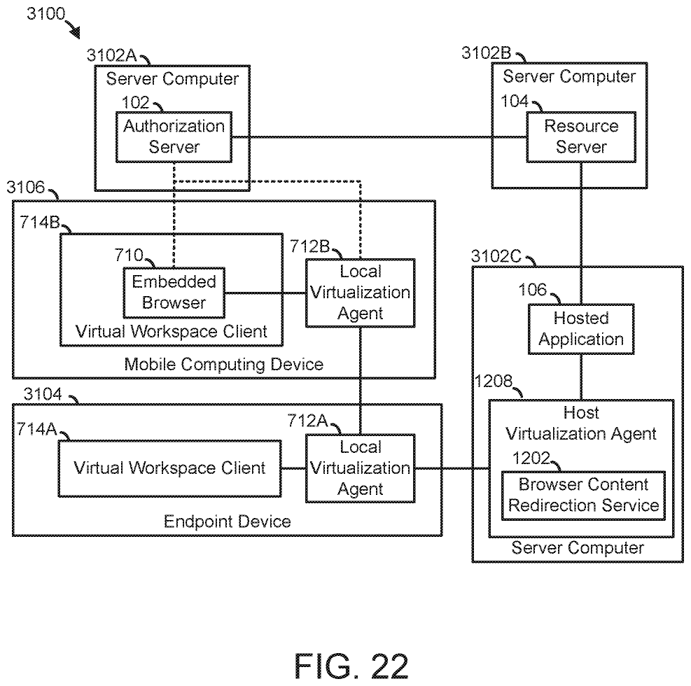

FIG. 22 illustrates another LAVA system (e.g., the LAVA system 1200 of FIG. 8) configured for operation within a distributed computing system 3100 comprising computing devices (e.g. the computing device 2900 of FIG. 20). As shown in FIG. 22, the distributed computing system 3100 includes server computers 3102A-3102C, an endpoint device 3104 and a mobile computing device 3106 that are configured to interoperate with one another via a network. The network is illustrated by lines connecting the computing devices.

The server computer 3102A is configured to host the authorization server 102 of FIG. 8. The server computer 3102B is configured to host the resource server 104 of FIG. 8. The server computer 3102C is configured to host the hosted application 106 and the host virtualization agent 1208 of FIG. 8. The endpoint device 3104 is configured to host a first instance 714A of a virtual workspace client and a first instance 712A of a local virtualization agent. The mobile computing device 3106 is configured to host a second instance 714B of the virtual workspace client and a second instance 712B of the local virtualization agent. The first and second instances 714A and 714B can be instances of, for example, the virtual workspace client 714 of FIG. 8. The first and second instances 712A and 712B can be instances of, for example, the local virtualization agent 712 of FIG. 8. Examples of the mobile computing device 3106, the endpoint device 3104, and the server computers 3102A-3102C include the computing device 2900 of FIG. 20.

In the distributed computing system 3100, the mobile computing device 3106 comprises a TPM, a biometric sensor, and a software configured to robustly authenticate a user of the hosted application 106. In one example, while accessing the hosted application 106 via the virtual workspace client 714A, a user wishes to provide the hosted application 106 access to a resource protected by the resource server 104. The user further wishes to authenticate herself as the owner of the protected resource using the biometric sensor of the mobile computing device, as such authentication is both secure and convenient.

The examples disclosed herein can be configured to support the user's desired process. For example, in response to receiving input from the user, the hosted application 106 can attempt to transmit an authorization request to the authorization server 102. This authorization request can be intercepted by the host virtualization agent 1208 and passed to the BCR service 1202. The BCR service can determine that the authorization request is subject to BCR and transmit a browser instantiation request and the authorization request to the local virtualization agent 712A. The local virtualization agent 712A can determine that the endpoint device is incapable of biometric authentication. In this situation, the local virtualization agent 712A transmits a request to the virtual workspace client 714A to prompt the user to unlock and securely pair the mobile computing device 3106 to the endpoint device 3104. The local virtualization agent 712A also begins transmitting requests to pair to the local virtualization agent 712B.

Continuing this example, after becoming active due to the unlocking of the mobile computing device, the local virtualization agent 712B establishes a secure communication channel with the local virtualization agent 712A. This secure communication channel can be established, for example, by one or more of BlueTooth, WiFi, near-field communication, and quick response code. To secure the secure communication channel, transport layer security (TLS) can be used over BlueTooth or WiFi. Certificates pinned at the local virtualization agents 712A and 712B can be used for client and server certificate authentication with TLS.

Next, the local virtualization agent 712A passes the browser instantiation request and the authorization request to the local virtualization agent 712B. The local virtualization agent 712B passes the browser instantiation request to the virtual workspace client 7143. The virtual workspace client 714B instantiates the embedded browser 710. The virtual workspace client passes the authorization request to the embedded browser 710. The embedded browser 710 transmits the authorization request to the authorization server and the two processes intemperate to authenticate the user as the consenting owner of the protected resource. In some examples, the embedded browser 710 communicates with the authorization server directly. In other examples, the embedded browser 710 communicates with the authorization server via the local virtualization agent 712B. The embedded browser receives the authorization response 212 and passes the authorization response 212 to the BCR service 1202. The BCR service 1202 passes the authorization response to the hosted application 106 and transmits a browser termination request to the embedded browser 710. The secure communication channel between the local virtualization agents 712A and 7123 is terminated. The hosted application 106 accesses a token within the authorization response and uses the token access the protected resource.

The distributed computing system 3100 is but one example of many potential configurations that can be used to implement LAVA systems. As such, the examples disclosed herein are not limited to the particular configuration of computing devise and other configurations are considered to fall within the scope of this disclosure.

### ADDITIONAL EXAMPLES

Descriptions of additional examples follow. Other variations will be apparent in light of this disclosure.

Example 1 is a computer system comprising a memory; a network interface; and at least one processor coupled to the memory and the network interface and configured to intercept a request transmitted by an application hosted within a virtual computing session, the request being a request to be authorized to access a resource; pass the request to a virtualization agent hosted outside the virtual computing session; receive a response to the request, the response including a credential granting authorization to access the resource; and pass the response to the application to authorize the application to access the resource through use of the credential.

Example 2 includes the subject matter of Example 1, the request comprising a scope parameter specifying a scope of access requested for the resource.

Example 3 includes the subject matter of Example 2, the response comprising a token granting the scope of access to the resource.

Example 4 includes the subject matter of any of Examples 1 through 3, further comprising the virtualization agent, the virtualization agent being configured to pass the request to a browser hosted locally to the virtualization agent.

Example 5 includes the subject matter of Example 4, the virtualization agent being further configured to receive the response and pass the response to another virtualization agent hosted within the virtual computing session.

Example 6 includes the subject matter of Example 5, the virtualization agent being further configured to intercept the response.

Example 7 includes the subject matter of any of Examples 4 through 6, further comprising the browser, the browser being configured to pass the response to one or more of the virtualization agent and another virtualization agent hosted within the virtual computing session.

Example 8 includes the subject matter of Example 7, the request comprising an authorization request, the response comprising an authorization response, and the browser being further configured to transmit the authorization request to an authorization server; receive, from the authorization server, a request to authenticate a user as an owner of the resource; authenticate the user as the owner of the resource using one or more of biometrics and multi-factor authentication; transmit, to the authorization server, a response to the request to authenticate the user; and receive the authorization response from the authorization server.

Example 9 includes the subject matter of any of Examples 1 through 8, the request comprising a callback parameter specifying a uniform resource identifier (URI) of the application.

Example 10 includes the subject matter of Example 9, further comprising the virtualization agent, the virtualization agent being configured to rewrite the callback parameter to specify a URI of the virtualization agent prior to passage of the request to a browser hosted locally with the virtualization agent.

Example 11 is a method of authorizing an application hosted within a virtual computing session to access at least one resource using a computer system, the method comprising intercepting a request transmitted by the application, the request being a request to be authorized to access the at least one resource; passing the request to a virtualization agent hosted outside the virtual computing session; receiving a response to the request, the response including a token granting authorization to access the at least one resource; and passing the response to the application to authorize the application to access the at least one resource through use of the token.

Example 12 includes the subject matter of Example 11, the intercepting comprising intercepting a request comprising a scope parameter specifying a scope of access.

Example 13 includes the subject matter of either Example 11 or Example 12, further comprising passing, by the virtualization agent, the request to a browser hosted locally to the virtualization agent.

Example 14 includes the subject matter of any of Examples 11 through 13, further comprising receiving, by the virtualization agent, the response; and passing, by the virtualization agent, the response to another virtualization agent hosted within the virtual computing session.

Example 15 includes the subject matter of either Example 13 or Example 14, further comprising passing, by the browser, the response to one or more of the virtualization agent and another virtualization agent hosted within the virtual computing session.

Example 16 includes the subject matter of any of Examples 13 through 15, the request comprising an authorization request, the response comprising an authorization response, and the method further comprising transmitting, by the browser, the authorization request to an authorization server; receiving, from the authorization server, a request to authenticate a user as an owner of the at least one resource; authenticating, by the browser, the user as the owner of the at least one resource using one or more of biometrics and multi-factor authentication; transmitting, to the authorization server, a response to the request to authenticate the user; and receiving, by the browser, the authorization response from the authorization server.

Example 17 includes the subject matter of any of Examples 11 through 16, further comprising rewriting a callback parameter of the request to specify a URI of the virtualization agent prior to passing the request to a browser hosted locally with the virtualization agent.

Example 18 is a non-transitory computer readable medium storing processor executable instructions to authorize an application hosted within a virtual computing session to access a resource using a computer system. The instructions comprise instructions to intercept a request transmitted by the application, the request being a request to be authorized to access the resource; pass the request to a virtualization agent hosted outside the virtual computing session; receive a response to the request, the response including a token granting authorization to access the resource; and pass the response to the application to authorize the application to access the resource through use of the token.

Example 19 includes the subject matter of Example 18, the instructions further comprising instructions to pass, by the virtualization agent, the request to a browser hosted locally to the virtualization agent.

Example 20 includes the subject matter of Example 19, the request comprising an authorization request, the response comprising an authorization response, and the instructions further comprising instructions to transmit, by the browser, the authorization request to an authorization server; receive, from the authorization server, a request to authenticate a user as an owner of the resource; authenticate, by the browser, the user as the owner of the resource using one or more of biometrics and multi-factor authentication; transmit, to the authorization server, a response to the request to authenticate the user; and receive, by the browser, the authorization response from the authorization server.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

The processes as disclosed herein each depict one particular sequence of operations in a particular example. Some operations are optional and, as such, can be omitted in accord with one or more examples. Additionally, the order of operations can be altered, or other operations can be added, without departing from the scope of the apparatus and methods described herein.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A computer system comprising:
a memory;
a network interface; and
at least one processor coupled to the memory and the network interface and configured to
intercept a request transmitted by an application hosted within a virtual computing session, the request being a request to be authorized to access a resource;
pass the request to a virtualization agent hosted outside the virtual computing session;
receive a response to the request, the response including a credential granting authorization to access the resource; and
pass the response to the application to authorize the application to access the resource through use of the credential.

2. The computer system of claim 1, the request comprising a scope parameter specifying a scope of access requested for the resource.

3. The computer system of claim 2, the response comprising a token granting the scope of access to the resource.

4. The computer system of claim 1, further comprising the virtualization agent, the virtualization agent being configured to pass the request to a browser hosted locally to the virtualization agent.

5. The computer system of claim 4, the virtualization agent being further configured to:
receive the response; and
pass the response to another virtualization agent hosted within the virtual computing session.

6. The computer system of claim 5, the virtualization agent being further configured to intercept the response.

7. The computer system of claim 4, further comprising the browser, the browser being configured to pass the response to one or more of the virtualization agent and another virtualization agent hosted within the virtual computing session.

8. The computer system of claim 7, the request comprising an authorization request, the response comprising an authorization response, and the browser being further configured to:
transmit the authorization request to an authorization server;
receive, from the authorization server, a request to authenticate a user as an owner of the resource;
authenticate the user as the owner of the resource using one or more of biometrics and multi-factor authentication;
transmit, to the authorization server, a response to the request to authenticate the user; and
receive the authorization response from the authorization server.

9. The computer system of claim 1, the request comprising a callback parameter specifying a uniform resource identifier (URI) of the application.

10. The computer system of claim 9, further comprising the virtualization agent, the virtualization agent being configured to rewrite the callback parameter to specify a URI of the virtualization agent prior to passage of the request to a browser hosted locally with the virtualization agent.

11. A method of authorizing an application hosted within a virtual computing session to access at least one resource using a computer system, the method comprising:
intercepting a request transmitted by the application, the request being a request to be authorized to access the at least one resource;
passing the request to a virtualization agent hosted outside the virtual computing session;
receiving a response to the request, the response including a token granting authorization to access the at least one resource; and
passing the response to the application to authorize the application to access the at least one resource through use of the token.

12. The method of claim 11, the intercepting comprising intercepting a request comprising a scope parameter specifying a scope of access.

13. The method of claim 11, further comprising passing, by the virtualization agent, the request to a browser hosted locally to the virtualization agent.

14. The method of claim 11, further comprising:
receiving, by the virtualization agent, the response; and
passing, by the virtualization agent, the response to another virtualization agent hosted within the virtual computing session.

15. The method of claim 13, further comprising passing, by the browser, the response to one or more of the virtualization agent and another virtualization agent hosted within the virtual computing session.

16. The method of claim 15, the request comprising an authorization request, the response comprising an authorization response, and the method further comprising:
transmitting, by the browser, the authorization request to an authorization server;
receiving, from the authorization server, a request to authenticate a user as an owner of the at least one resource;
authenticating, by the browser, the user as the owner of the at least one resource using one or more of biometrics and multi-factor authentication;
transmitting, to the authorization server, a response to the request to authenticate the user; and
receiving, by the browser, the authorization response from the authorization server.

17. The method of claim 11, further comprising rewriting a callback parameter of the request to specify a URI of the virtualization agent prior to passing the request to a browser hosted locally with the virtualization agent.

18. A non-transitory computer readable medium storing processor executable instructions to authorize an application hosted within a virtual computing session to access a resource using a computer system, the instructions comprising instructions to:
intercept a request transmitted by the application, the request being a request to be authorized to access the resource;
pass the request to a virtualization agent hosted outside the virtual computing session;
receive a response to the request, the response including a token granting authorization to access the resource; and
pass the response to the application to authorize the application to access the resource through use of the token.

19. The non-transitory computer readable medium of claim 18, the instructions further comprising instructions to pass, by the virtualization agent, the request to a browser hosted locally to the virtualization agent.

20. The non-transitory computer readable medium of claim 19, the request comprising an authorization request, the response comprising an authorization response, and the instructions further comprising instructions to:
transmit, by the browser, the authorization request to an authorization server;
receive, from the authorization server, a request to authenticate a user as an owner of the resource;
authenticate, by the browser, the user as the owner of the resource using one or more of biometrics and multi-factor authentication;
transmit, to the authorization server, a response to the request to authenticate the user; and
receive, by the browser, the authorization response from the authorization server.
